(19) United States
(12) Patent Application Publication
(10) Pub. No.: US 2023/0214921 A1
(43) Pub. Date: Jul. 6, 2023

(54) TRADING STRATEGY BACKTESTING METHOD AND APPARATUS, AND STORAGE MEDIUM

(71) Applicant: FUTU NETWORK TECHNOLOGY (SHENZHEN) CO., LTD., Shenzhen (CN)

(72) Inventor: Xiaoquan FENG, Shenzhen (CN)

(21) Appl. No.: 17/986,801

(22) Filed: Nov. 14, 2022

Related U.S. Application Data
(63) Continuation of application No. PCT/CN2021/143159, filed on Dec. 30, 2021.

(51) Int. Cl. G06Q 40/04

(52) U.S. Cl. CPC G06Q 40/04

(57) ABSTRACT

Provided are a trading strategy backtesting method and apparatus, and a storage medium. The method includes: providing a display interface with a graphical function interface, the display interface being configured to provide a display interface for a trading strategy and an editing interface for a trading strategy element; generating a target trading strategy in response to a strategy editing operation for the editing interface, and converting the target trading strategy into a corresponding strategy script, the target trading strategy including a strategy condition for at least one of cross-market, cross-category, and cross-cycle; obtaining backtesting data corresponding to the target trading strategy; performing a backtesting process on the target trading strategy based on the backtesting data and the strategy script to generate a backtesting report, the backtesting report including a backtesting image corresponding to backtesting time; and displaying the backtesting image in the backtesting report dynamically based on the display interface.

### CROSS-REFERENCE TO RELATED APPLICATIONS

The present application is a continuation of International Application No. PCT/CN2021/143159 filed on Dec. 30, 2021, which is hereby incorporated by reference in its entirety.

### FIELD

The present disclosure relates to the field of computer technology, and more particularly, to a trading strategy backtesting method, a trading strategy backtesting apparatus, and a storage medium.

### BACKGROUND

At present, there are a plurality of strategy backtesting systems on the market that support backtesting, but they only support single-market, single-category, or single-currency backtesting schemes, and cannot achieve more complex strategy construction and strategy backtesting and thus have low effectiveness and low accuracy of strategies.

### SUMMARY

### Technical Problem

Embodiments of the present disclosure provide a trading strategy backtesting method, a trading strategy backtesting apparatus, and a storage medium, capable of achieving a strategy backtesting scheme for at least one of cross-market, cross-category, and cross-cycle, to improve the effectiveness and accuracy of strategies.

### Technology Solutions

In one aspect, a trading strategy backtesting method is provided. The method includes: providing a display interface with a graphical function interface, the display interface being configured to provide a display interface for a trading strategy and an editing interface for a trading strategy element; generating a target trading strategy in response to a strategy editing operation for the editing interface, and converting the target trading strategy into a corresponding strategy script, the target trading strategy including a strategy condition for at least one of cross-market, cross-category, and cross-cycle; obtaining backtesting data corresponding to the target trading strategy; performing a backtesting process on the target trading strategy based on the backtesting data and the strategy script to generate a backtesting report, the backtesting report including a backtesting image corresponding to backtesting time; and displaying the backtesting image in the backtesting report dynamically based on the display interface.

In another aspect, a trading strategy backtesting apparatus is provided. The apparatus includes: a providing unit configured to provide a display interface with a graphical function interface, the display interface being configured to provide a display interface for a trading strategy and an editing interface for a trading strategy element; a generating unit configured to generate a target trading strategy in response to a strategy editing operation for the editing interface, and convert the target trading strategy into a corresponding strategy script, the target trading strategy including a strategy condition for at least one of cross-market, cross-category, and cross-cycle; an obtaining unit configured to obtain backtesting data corresponding to the target trading strategy; a backtesting unit configured to perform a backtesting process on the target trading strategy based on the backtesting data and the strategy script to generate a backtesting report, the backtesting report including a backtesting image corresponding to backtesting time; and a display unit configured to display the backtesting image in the backtesting report dynamically based on the display interface.

In another aspect, a computer-readable storage medium is provided. The computer-readable storage medium has a computer program stored thereon. The computer program is adapted to be loaded onto a processor for performing the steps in the trading strategy backtesting method according to the first aspect.

In another aspect, a terminal device is provided. The terminal device includes a processor and a memory. The memory has a computer program stored thereon, and the processor invokes the computer program stored in the memory for performing the steps in the trading strategy backtesting method according to the first aspect.

### Advantageous Effects

Embodiments of the present disclosure provides a trading strategy backtesting method and apparatus, and a storage medium. In the trading strategy backtesting method and apparatus, and the storage medium, a display interface with a graphical function interface is provided. The display interface is configured to provide a display interface for a trading strategy and an editing interface for a trading strategy element. In response to a strategy editing operation for the editing interface, a target trading strategy is generated, and the target trading strategy is converted into a corresponding strategy script. The target trading strategy includes a strategy condition for at least one of cross-market, cross-category, and cross-cycle. Backtesting data corresponding to the target trading strategy is obtained. A backtesting process is performed on the target trading strategy based on the backtesting data and the strategy script to generate a backtesting report. The backtesting report includes a backtesting image corresponding to backtesting time. Based on the display interface, the backtesting image in the backtesting report is displayed dynamically. In the embodiments of the present disclosure, the display interface with the graphical functional interface can be used to achieve the construction of the trading strategy and achieve a strategy backtesting scheme for at least one of cross-market, cross-category, and cross-cycle, so as to improve the effectiveness and accuracy of the strategy, dynamically display the backtesting report, and improve the display effect.

### BRIEF DESCRIPTION OF DRAWINGS

In order to clearly explain technical solutions of embodiments of the present disclosure, drawings used in the embodiments are briefly described below. Obviously, the drawings as described below are merely some embodiments of the present disclosure. Based on these drawings, other drawings can be obtained by those skilled in the art without inventive effort.

FIG. 1 is a schematic flowchart of a trading strategy backtesting method according to an embodiment of the present disclosure.

FIG. 2 is a schematic diagram of a first application scenario according to an embodiment of the present disclosure.

FIG. 3 is a schematic diagram of a second application scenario according to an embodiment of the present disclosure.

FIG. 4 is a schematic diagram of a third application scenario according to an embodiment of the present disclosure.

FIG. 5 is a schematic diagram of a fourth application scenario according to an embodiment of the present disclosure.

FIG. 6 is a schematic diagram of a fifth application scenario according to an embodiment of the present disclosure.

FIG. 7 is a schematic diagram of a sixth application scenario according to an embodiment of the present disclosure.

FIG. 8 is a schematic diagram of a framework of a backtester according to an embodiment of the present disclosure.

FIG. 9 is another schematic flowchart of a trading strategy backtesting method according to an embodiment of the present disclosure.

FIG. 10 is another schematic flowchart of a trading strategy backtesting method according to an embodiment of the present disclosure.

FIG. 11 is a schematic structural diagram of a trading strategy backtesting apparatus according to an embodiment of the present disclosure.

FIG. 12 is a schematic structural diagram of a terminal device according to an embodiment of the present disclosure.

### DESCRIPTION OF EMBODIMENTS

The technical solutions in the embodiments of the present disclosure are clearly and completely described below combined with the drawings in the embodiments of the present disclosure. It is clear that the embodiments described are only some of the embodiments of the present disclosure, not all embodiments. Based on the embodiments in the present disclosure, all other embodiments obtained by those skilled in the art without inventive effort are to be encompassed by the scope of protection of the present disclosure.

Embodiments of the present disclosure provide a trading strategy backtesting method and apparatus, a terminal device, and a storage medium. Specifically, the trading strategy backtesting method according to the embodiments of the present disclosure may be performed by a terminal device, where the terminal device may be a terminal or a server or other device. The terminal may be a smartphone, a tablet computer, a laptop, a touch screen, a game console, a Personal Computer (PC), a Personal Digital Assistant (PDA), or any other terminal device. The server can be an independent physical server, a server cluster or distributed system composed of a plurality of physical servers, or a cloud server that provides cloud services, cloud databases, cloud computing, cloud functions, cloud storage, network services, cloud communications, middleware services, domain name services, security services, content delivery network services, big data, artificial intelligence platforms, and other basic cloud computing services. The present disclosure is not limited to any of these examples.

Some of the words or terms used herein for describing the embodiments of the present disclosure are explained as follows.

Trading strategy: it is a set of rules which includes data rules regarding how to make decisions to buy and sell. The trading strategy can be divided into three parts: an indicator, a signal, and a rule. Here, the indicator is used to generate a trading signal. There are many ways to calculate the indicator, which can be economic data or a valuation indicator, or a technical indicator. The interaction of a price and an indicator forms a signal. The rule is about how to react to a signal, and the rule is the core of a trading strategy. Once a trading strategy is written into codes or a program, it can be called a quantitative trading, with all trading behaviors executed automatically. The biggest advantage of the quantitative trading is that it can avoid emotional fluctuations to reduce impulsive trading patterns caused by subjective thinking. There are two common ways to test a trading strategy. One is backtesting, which is a process of verifying the feasibility and effectiveness of a trading strategy based on historical data. The purpose of backtesting is to use the performance after the backtesting to evaluate the performance in a real market in the future. The other is paper trading, also known as forward testing, which uses a demo account and real data to evaluate a trading model.

K-line: it generally refers to a K-line chart. The K-line chart in the stock market and futures market contains four data items: an opening price, a highest price, a lowest price, and a closing price, and all the k-lines are drawn based on these four data items, reflecting the general trend and price information. Based on calculation cycles of K-lines, they can be divided into daily K-lines, weekly K-lines, monthly K-lines, and annual K-lines. For example, a weekly K-line is a K-line chart drawn with Monday's opening price, Friday's closing price, the highest price in the week, and the lowest price in the week. The monthly K-line is a K-line chart drawn with an opening price on the first trading day of a month, a closing price on the last trading day of the month, the highest price in the month, and the lowest price in the month. The definition of the annual K-line can be obtained in the similar way. Weekly K-lines and monthly K-lines are often used to judge the medium-term market performance.

Right exclusion: it is a term for a company to regularly fulfill its commitment to distribute the benefits to the shareholders for the rights (shares) they hold.

Adjustment: the essence is to use univariate control in mathematics to correct prices on a K-line chart by means of mathematical conversion, and eliminate the jump of points on the chart caused by right exclusion and dividend exclusion. For investors, it is to repair the rights and dividends of stocks and eliminate the distortion in the trends of price and indicator caused by the right exclusion and dividend exclusion. It is mainly to determine whether the current stock price is at a relatively high or low level in history for a long period of time. The method of adjustment includes forward adjustment and backward adjustment, which are to convert the stock prices before and after the right exclusion date based on the stock price on the right exclusion date, respectively.

Forward adjustment: the price before the right exclusion is converted based on the current price, and after the right exclusion, the current price remains unchanged, and the previous price is reduced.

Backward adjustment: the price after the right exclusion is converted based on the previous price, and after the right exclusion, the previous price remains unchanged, and the current price is increased.

No adjustment: after the right exclusion, the huge gap in the stock price trend diagram will not be filled manually, allowing the gap to exist.

One lot: it indicates the most basic trading unit in the futures market, and for different futures varieties in futures trading, “one lot” means different amounts, e.g., one lot of stocks is equal to 100 shares.

Minimum trading unit: it represents the minimum declared unit of buying and selling securities.

Time series: it refers to a series of data obtained at consecutive intervals with equal time lengths. In quantitative investment, such data is mainly expressed as movement of prices and data points of the investment target that is being tracked.

Tick data: it is the most detailed trading data structure in the exchange. Tick data is also an extended form of time series data, including an opening price, a highest price, a lowest price, a latest price, a volume, a turnover, etc.

Embodiments of the present disclosure provide a trading strategy backtesting method, a trading strategy backtesting apparatus, a terminal device, and a storage medium, capable of achieving construction of a trading strategy by providing a display interface with a graphical function interface, and achieving a strategy backtesting scheme for at least one of cross-market, cross-category, and cross-cycle, so as to improve the effectiveness and accuracy of the strategy, dynamically display the backtesting report, and improve the display effect.

The embodiments will be described in detail below. It should be noted that the order of description of the following embodiments does not constitute any restriction on the priority of the order of the embodiments.

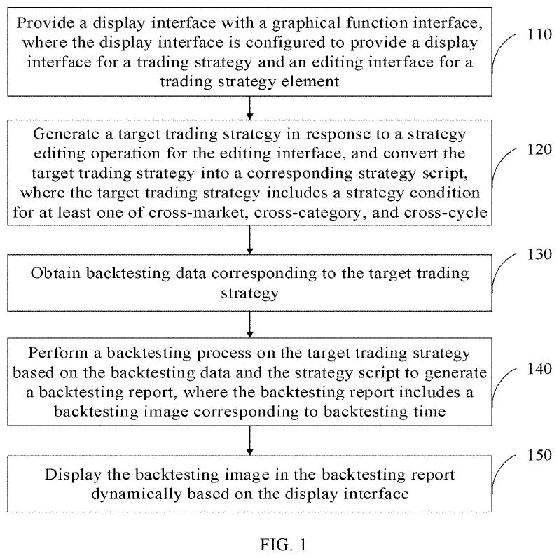

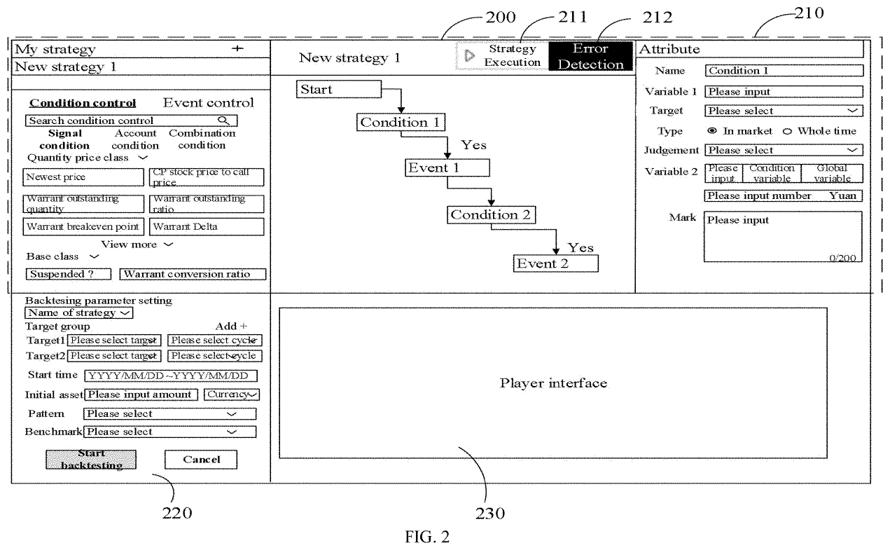

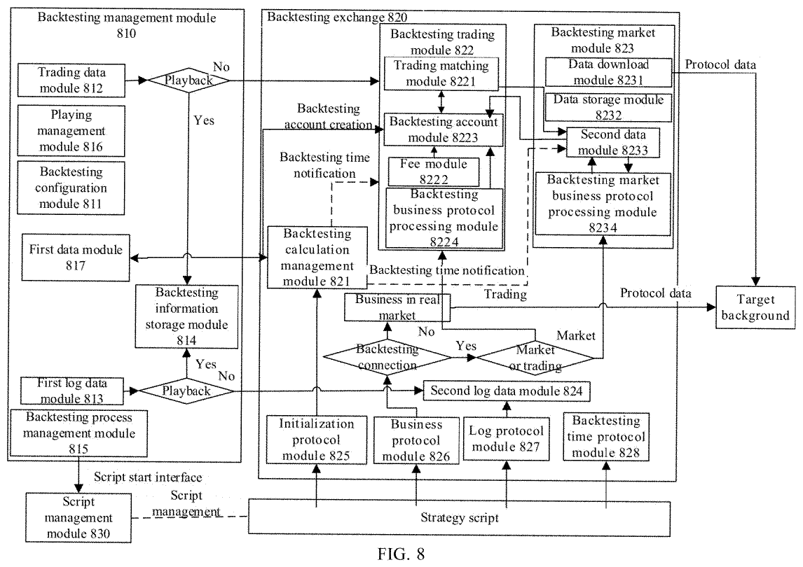

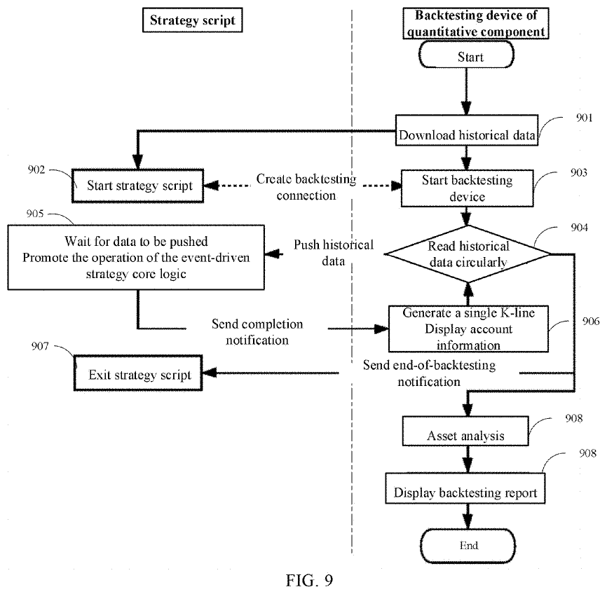

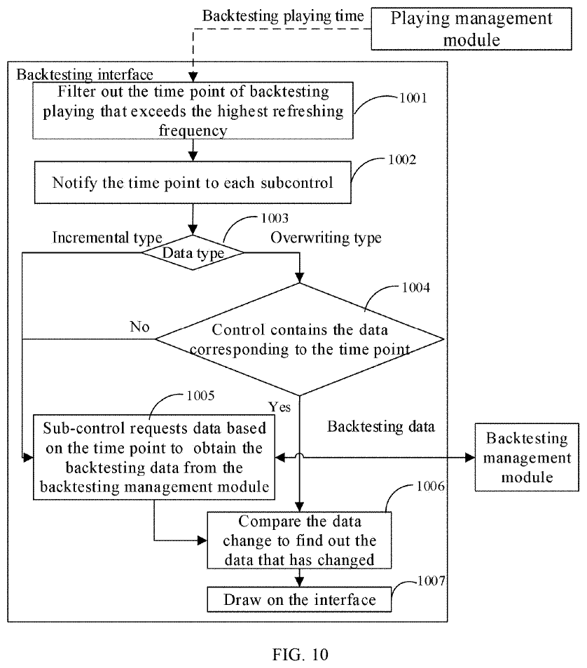

Referring to FIG. 1 to FIG. 10, FIG. 1, FIG. 9, and FIG. 10 are schematic flowcharts of trading strategy backtesting methods according to the embodiments of the present disclosure, FIGS. 2 to 7 are schematic diagrams of application scenarios according to the embodiments of the present disclosure, and FIG. 8 is a schematic diagram of a framework of a backtester according to an embodiment of the present disclosure. The trading strategy backtesting method according to the embodiments of the present disclosure may be applied to the trading strategy backtesting apparatus according to the embodiments of the present disclosure, and the trading strategy backtesting apparatus may be configured on the terminal device. The terminal device may be configured with a backtester as illustrated in FIG. 8. The method includes the following steps.

At step 110, a display interface with a graphical function interface is provided. The display interface is configured to provide a display interface for a trading strategy and an editing interface for a trading strategy element.

For example, the display interface with the graphical function interface can be provided, the display interface can be configured to provide the display interface for the trading strategies and the editing interface for the trading strategy element.

For example, the display interface may include a series of data-driven based wizard configuration interfaces, such as a strategy configuration interface, a trading operation interface, a trading condition configuration interface, a risk control condition configuration interface, a backtesting configuration interface, a player interface, etc., to guide a user to configure and edit a trading strategy visually and display the trading strategy and its corresponding backtesting report via the display interface. For example, elements for editing the trading strategy may include a trading target, a strategy condition, a trigger event, backtesting time, an execution frequency, etc. The editing interface corresponds to the elements, and various elements of the trading strategy can be edited in the editing interface. For example, the display interface includes a player, which may be a video player.

At step 120, in response to a strategy editing operation for the editing interface, a target trading strategy is generated, and the target trading strategy is converted into a corresponding strategy script. The target trading strategy includes a strategy condition for at least one of cross-market, cross-category, and cross-cycle.

For example, the user can, on the display interface, drag and drop some graphical controls or graphical editing interfaces or edit corresponding conditions or events, such that the terminal device can respond to the strategy editing operation for the editing interface and connect the edited conditions or events into a flowchart to complete construction of locally programmed trading strategy ideas, so as to generate the target trading strategy, and compile the target trading strategy into a corresponding strategy execution file to obtain the corresponding strategy script. By providing the display interface with the graphical function interface to quantify the components, the efficiency and speed for the user to create programmed strategies can be improved, the technical threshold can be reduced, and the needs of users who want to access computer programmed trading but do not know how to program can be satisfied.

For example, for the display interface illustrated in FIG. 2, the display interface 200 currently displays a strategy configuration interface 210 corresponding to the editing interface, a backtesting configuration interface 220, a player interface 230 corresponding to the display interface. For example, a newly created strategy can be displayed in “My strategy” on the display interface 200, such as “New strategy 1”. The user performs the corresponding strategy editing operation in a corresponding attribute window corresponding to the condition control or event control to edit the condition and event of “New strategy 1”, and finally constructs “New strategy 1”. Here “New strategy 1” is the target trading strategy.

For example, the condition control may include a signal condition, an account condition, a combined condition and the like. For example, a strategy condition for cross-market, cross-category, and cross-cycle can be set in the combined condition. For example, a strategy condition for any one of cross-market, cross-category, and cross-cycle can be set, and strategy conditions of at least two of cross-market, cross-category, and cross-cycle can be set in combination.

For example, a strategy execution control 211 and an error detection control 212 are provided on the display interface 200 illustrated in FIG. 2. For example, in response to a touch operation on the strategy execution control 211, the generated target trading strategy may be executed. For example, in response to a touch operation on the error detection control 212, an error detection is performed on the generated target trading strategy.

At step 130, backtesting data corresponding to the target trading strategy is obtained.

For example, in response to a backtesting request, the backtesting data corresponding to the target trading strategy is obtained based on a condition, an event, a configuration parameter, an attribute parameter, and the like, set by the target trading strategy. The obtained backtesting data is historical data.

At step 140, based on the backtesting data and the strategy script, a backtesting process is performed on the target trading strategy, to generate a backtesting report. The backtesting report includes a backtesting image corresponding to backtesting time.

For example, if a trading strategy created by a user is executed directly in the real market, it may result in loss of real money. In a process of creating a trading strategy, if no visual effect is provided to verify the operating effect of the strategy, the user may be worried very much about the effectiveness of the trading strategy. By designing the backtesting function, the user can verify the effectiveness of the strategy, which can effectively avoid errors and logic loopholes in the process of creating the strategy, and ensure that the strategy performance meets expectations.

At present, there are a number of financial software products on the market that support backtesting, but have the following disadvantages. They do not support backtesting for portfolios established across multiple markets. They do not support backtesting for portfolios established across categories. They only support a fixed cycle for backtesting, and the determination conditions are strongly coupled with the cycle of backtesting data, thus the user cannot freely combine the conditions of different cycles. Compared with the current backtesting schemes that only support a single market, a single category, and a single currency, the embodiments of the present disclosure may support backtesting for cross-market, cross-category, and cross-cycle.

In some embodiments, when the target trading strategy includes the strategy condition for cross-market, the obtained backtesting data may include historical data corresponding to the trading target in different markets.

The above operation of performing the backtesting process on the target trading strategy based on the backtesting data and the strategy script to generate the backtesting report may include: determining a virtual account with a single-currency deposit among at least one virtual account corresponding to a target user as the target account; and determining, during the backtesting process, when a first currency as a denomination currency for the transaction target and a second currency as a deposit currency in the target account are inconsistent, an amount in the second currency corresponding to the denomination currency for the trading target currency based on a historical exchange rate between the first currency and the second currency, and performing the backtesting process on the target trading strategy based on the amount in the second currency corresponding to the denomination currency of the trading target to generate the backtesting report for characterizing the cross-market.

For example, in the embodiments of the present disclosure, the backtesting for the cross-market can be achieved. The backtesting for the cross-market supports backtesting for cross-market portfolios, and backtesting of multi-currency trading targets can be achieved for one single account.

The main difficulty for cross-market is that the denomination currency of the trading target in different markets may be different, thus how to break through the barriers of the denomination currencies, and build a unified, cross-currency purchasing power system.

Different markets correspond to exchange markets in different regions, such as the Hong Kong stock market, the US stock market, the Chinese stock market, the Singapore stock market, etc., and the denomination currencies of the trading target in different markets correspond to the currencies in the respective regions.

For example, a currency refers to the denomination currency of the trading target. In some exchanges, there are trading targets in different denomination currencies. For example, the denomination currency of a trading target with a code of CNmain is US dollar, and the denomination currency of a trading target with a code of UCmain is RMB, both of which can be traded in the Singapore stock market.

For example, during the backtesting process, a virtual account with only a single-currency deposit is used, and the virtual account with the single-currency deposit, among the at least one virtual account corresponding to the target user, is determined as the target account. For example, when placing an order in backtesting, if the first currency as the denomination currency for the trading target and the second currency as the deposit currency in the account are inconsistent, the amount in the second currency corresponding to the denomination currency is determined based on the historical exchange rate between the first currency and the second currency, the required margin and purchasing power are calculated based on the amount in the second currency corresponding to the denomination currency for the trading target, and an order situation of the order corresponding to the trading target is simulated. Based on the margin and the purchasing power, and the order situation of the order corresponding to the trading target, the backtesting process is performed on the target trading strategy to generate the backtesting report for characterizing the cross-market. This approach is also closer to the actual situation where the target user uses a real all-round account.

For example, account assets may include: cash, stocks, options, etc. A unified purchasing power can be set to achieve multi-currency pricing. For example, cash can contribute directly to the purchasing power at 100%, stocks can contribute to the purchasing power at a specific proportion (e.g. 45%), and the purchasing power corresponding to the contribution of all assets in the account can be aggregated to obtain the unified purchasing power.

For example, the unified purchasing power can be used for subsequent purchases of stocks. Since the unified purchasing power corresponds to multiple currencies, buying Stock X directly occupies the purchasing power corresponding to the currency of the current stock, and the unified purchasing power in other currencies can be calculated and deducted in accordance with the real-time exchange rate.

For example, an account of the user with unified purchasing power is equivalent to having the ability of pledge financing. For example, the account of the user may pledge some cash (CNH) and stocks that can be pledged (HKD), such that the account of the user can have the unified purchasing power and the ability to purchase a target with another denomination currency (USD).

For example, if the account of the user does not have the unified purchasing power, it means that the account of the user does not have the ability of pledge financing. For the account of the user that does not have the unified purchasing power, stocks in USD cannot be purchased if USD cash in the account is equal to 0.

In some embodiments, when the target trading strategy includes the strategy condition for cross-category, the obtained backtesting data may include historical data corresponding to trading targets in different categories.

The operation of performing the backtesting process on the target trading strategy based on the backtesting data and the strategy script to generate the backtesting report may include: obtaining historical K-line data corresponding to all trading targets in the backtesting data, and marking time information of the historical K-line data based on timestamps; and managing, during the backtesting process, a backtesting progress based on the timestamps, to generate the backtesting report for characterizing the cross-category based on different time intervals and the time information of the historical K-line data.

For example, the embodiments of the present disclosure may achieve the backtesting for cross-category. The backtesting for the cross-category supports the backtesting for cross-category portfolios, and supports hedging stocks with derivatives.

The main difficulty for cross-category is that the transaction time and risk control systems for different categories are different, and thus how to use one risk control system to solve the problem in the scenario of multi-category portfolios, and how to establish one comprehensive account system and use one account to solve the problem in establishment of a multi-category asset system.

For example, different categories include various trading targets such as stocks, funds, futures, options, etc.

During the backtesting process, the historical K-lines used for the backtesting process are all saved in the local terminal, and K-line time is marked with timestamps to ensure that the timing for the backtesting is correct and no future data will be generated. A backtesting management module will manage the backtesting progress based on the timestamps, and either intraday or post-market, the backtesting management module will promote the backtesting progress based on different granularities (time intervals). Company actions (stock-split, stock-merger, dividend, etc.) are carried out during the closed period, and the company actions will affect the user orders and positions for the backtesting, so it is also necessary to execute the company actions and calculate data changes caused by the company actions in the backtesting management module.

In some embodiments, when the target trading strategy includes the strategy condition for cross-cycle, the obtained backtesting data may include historical data corresponding to a trading target in different cycles.

The operation of performing the backtesting process on the target trading strategy based on the backtesting data and strategy script to generate the backtesting report may include: obtaining historical K-line data corresponding to the trading target in different cycles in the backtesting data; and re-aggregating, during the backtesting process, when a K-line in first historical K-line data corresponding to a first cycle in different cycles has not ended, for generating the backtesting image, a K-line corresponding to the first historical K-line data based on a predetermined cycle and the first historical K-line data corresponding to the first cycle, to generate the backtesting report for characterizing the cross-cycle. A time length of the first cycle is greater than a time length of the predetermined cycle.

For example, the embodiments of the present disclosure may achieve the backtesting for cross-cycle. The backtesting for the cross-cycle supports backtesting for different cycles, and can support up to the tick level.

The main difficulty for cross-cycle time processing is that trading time of trading targets in different markets may be different, and thus how to solve the problem of misalignment of the trading time, align the time lines of multiple categories and multiple cycles, and reproduce the real scene as much as possible.

For example, in actual trading, the strategy program can request a price trend of any K-line cycle at any time point, and can also compare the trading targets in multiple markets and in multiple categories horizontally. The trading time for the categories in different markets may be misaligned. During the backtesting process, the historical K-line data of all cycles is stored in the local terminal. When the K-line of the first cycle (large cycle) has not yet closed, it is necessary to use the K-line of a predetermined cycle (such as 1 minute) for aggregation into the K-line corresponding to the historical K-line data of the first cycle displayed in the backtesting image to avoid future data. For example, after closing of the previous day, before opening of the next day, the latest price that can be obtained should be the closing price of the K-line of the previous day.

In some embodiments, when the target trading strategy includes the strategy conditions for cross-market and cross-category, the obtained backtesting data may include historical data corresponding to trading targets in different markets and different categories.

The operation of performing the backtesting process on the target trading strategy based on the backtesting data and the strategy script to generate the backtesting report may include: determining a virtual account with a single-currency deposit among at least one virtual account corresponding to a target user as a target account; determining, when a first currency as a denomination currency of the trading targets and a second currency as a deposit currency in the target account are inconsistent, an amount in the second currency corresponding to the denomination currency for the trading targets based on a historical exchange rate between the first currency and the second currency; obtaining historical K-line data corresponding to all the trading targets in the backtesting data, and marking time information of the historical K-line data based on timestamps; and managing, during the backtesting process, a backtesting progress based on the timestamps, to perform the backtesting process on the target trading strategy, based on different time intervals, the time information of the historical K-line data, and the amount in the second currency corresponding to the denomination currency for the trading targets, to generate the backtesting report for the cross-market and the cross-category.

For example, a market may include a plurality of categories (such as stocks, funds, etc.), a category may include different trading targets, each having a corresponding denomination currency, so the embodiments of the present disclosure can achieve combined backtesting for cross-market and cross-category.

In some embodiments, when the target trading strategy includes the strategy conditions for cross-market and cross-cycle, the obtained backtesting data may include historical data corresponding to trading targets in different markets and different cycles.

The operation of performing the backtesting process on the target trading strategy based on the backtesting data and the strategy script to generate the backtest report may include: determining a virtual account with a single-currency deposit among at least one virtual account corresponding to a target user as a target account; determining, when a first currency as a denomination currency for the trading targets and a second currency as a deposit currency in the target account are inconsistent, an amount in the second currency corresponding to the denomination currency for the trading target based on a historical exchange rate between the first currency and the second currency; obtaining historical K-line data corresponding to all trading targets in the backtesting data; re-aggregating, when a K-line in first historical K-line data corresponding to a first cycle in the different cycles has not ended, a K-line corresponding to the first historical K-line data corresponding to a predetermined cycle and the first historical K-line data corresponding to the first cycle, where a time length of the first cycle is greater than a time length of the predetermined cycle; and performing the backtesting process on the target trading strategy based on the amount in the second currency corresponding to the denomination currency for the trading target, and the re-aggregated K-line corresponding to the first historical K-line data, to generate the backtesting report for characterizing the cross-market and the cross-cycle.

In some embodiments, when the target trading strategy includes strategy conditions for cross-market, cross-category and cross-cycle, the obtained backtesting data may include historical data corresponding to trading targets in different markets, different categories, and different cycles.

The operation of performing the backtesting process on the target strategy based on the backtesting data and the strategy script to generate the backtesting report may include: determining a virtual account with a single-currency deposit among at least one virtual account corresponding to a target user as a target account; determining, when a first currency as a denomination currency for the trading targets and a second currency as a deposit currency in the target account are inconsistent, an amount in the second currency corresponding to the denomination currency for the trading targets based on a historical exchange rate between the first currency and the second currency; obtaining historical K-line data corresponding to all trading targets in the backtesting data, and marking time information of the historical K-line data based on timestamps; re-aggregating, when a K line in the first historical K line data corresponding to the first cycle in the different cycles has not ended, a K line corresponding to the first historical K line data based on a predetermined cycle and the first historical K-line data corresponding to the first cycle, where a time length of the first cycle is greater than a time length of the predetermined cycle; and managing, during the backtesting process, a backtesting progress based on the timestamps, to perform the backtesting process on the target trading strategy, based on different time intervals, the time information of the historical K-line data, the amount in the second currency corresponding to the denomination currency for the trading targets, and the re-aggregated K-line corresponding to the first historical K-line data, to generate the backtesting report characterizing the cross-market, the cross-category, and the cross-cycle.

When multiple trading targets in the obtained backtesting data belong to different trading markets, the backtesting for cross-market can be achieved and the backtesting report for characterizing the cross-market can be generated. For example, when multiple trading targets in the obtained backtesting data belong to the same market and correspond to different categories, the backtesting for cross-category can be achieved in the same market and the backtesting report for characterizing cross-category can be generated. For example, when multiple trading targets in the obtained backtesting data belong to the same market, the same category, and correspond to different trading cycles, the backtesting for cross-cycle can be achieved in the same market and in the same category. When multiple trading targets in the obtained backtesting data belong to different trading markets and different categories, the backtesting for cross-market, cross-category, and cross-cycle can be achieved, and the backtesting report for characterizing the cross-market, the cross-category, and the cross-cycle can be generated.

In some embodiments, during the backtesting process, the method may further include: performing, when the backtesting processing includes at least one of position processing, cash processing, and order processing, the backtesting process by means of dynamic forward adjustment. The dynamic forward adjustment is to trigger forward adjustment once for all data before a current moment whenever at least one event of stock-split, stock-merger, and dividend occurs for a target company in the backtesting data.

During the backtesting process, historical company actions may cause a gap in the stock price. Most of the commonly used technical indicators are continuous, such as moving averages, MACDs, Bollinger bands, etc. Abnormal gaps may cause the technical indicators to be not smooth enough and lose their significance as guides.

Some of the current backtesting systems use one-time forward adjusted data or one-time backward adjusted data for backtesting, and the trading prices are quite different from the real historical prices, and there may be future data. For example, in order to make price trends comparable, investors generally use the method of forward adjustment to view in real trading. However, directly using the forward adjusted historical data for backtesting may lead to the following problems. Due to long-term dividends, some companies have negative historical stock prices after the forward adjustment, and during the backtesting process, trading the assets having the negative prices not only is obviously unreasonable, but also deviates from the real scene. There may be more than one company action points in the entire backtesting cycle. If forward adjusted data is directly used for backtesting, it is equivalent to introducing future data, that is, the price at a previous historical moment has implied the adjustment information at a later historical moment, which results in that the entire backtesting process is inaccurate. In order to solve the above problems, some backtesting systems use backward adjusted historical data for backtesting, but other problems are introduced. Some stocks continue to pay dividends, and the backward adjusted data is likely to produce high-priced stocks. For the position management of the strategy, the high stock prices can easily cause idle funds, and if the strategy itself is relatively sensitive to position management, this method may not be able to accurately measure its effectiveness. Taking the backward adjusted data of Company A's stock as an example, the backward adjusted stock price is about 3,000, and at the minimum trading unit, it needs 300,000 RMB per lot. If the initial capital for the backtesting is 1 million RMB, then only 3 lots can be bought at most, and the remaining 100,000 RMB cannot participate in the strategy, and 10% of the positions are always idle.

In view of the above defects, in the embodiment of the present disclosure, the backtesting process is chosen to be performed by means of dynamic forward adjustment. In the embodiments of the present disclosure, the historical company actions may be performed by means of dynamic forward adjustment to restore historical real stock-split or stock-merger and dividend, and to avoid future data. When placing an order, the real market price at that time is used for trading (the latest non-adjusted price and the latest dynamically forward adjusted price are consistent). When technical indicators are used, this can ensure that the K-lines in the past are smooth.

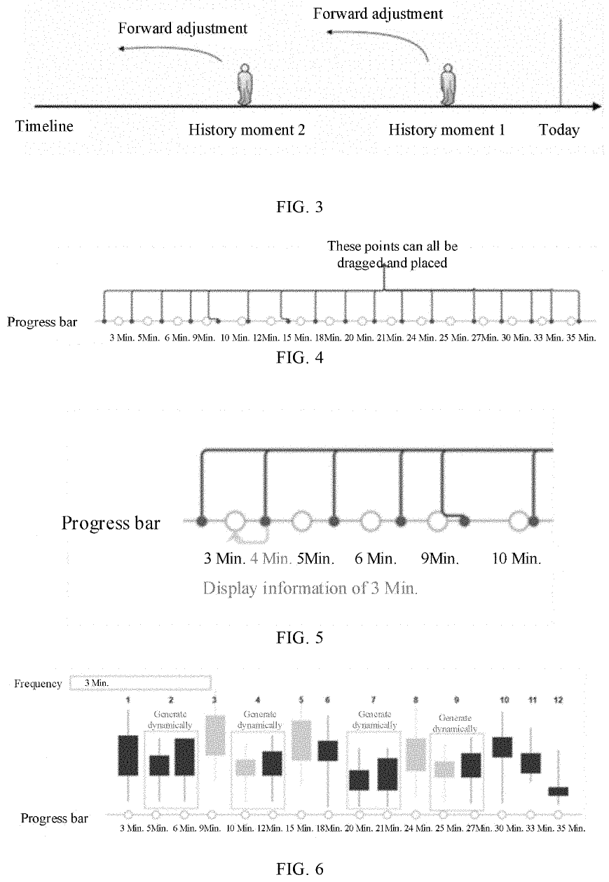

For example, as illustrated in FIG. 3, with the timeline as the axis, trading is performed based on the real market price as reflected by the current dynamic forward adjustment at each historical moment.

Here, the dynamic forward adjustment involves phase-by-phase adjustment of the target stock with respect to multiple historical company actions. A forward adjustment module for handling company actions can be introduced separately. Whenever the target company has an event such as a stock-split or stock-merger, dividend, etc., the forward adjustment module will trigger forward adjustment once for all data before the current moment.

For example, for data related to price and volume, the following formula can be adopted:

forward adjusted price=non-adjusted price×forward adjustment factor A+forward adjustment factor B; and

forward adjusted volume=non-adjusted volume/forward adjustment factor A.

When the dynamic forward adjustment is used to perform the backtesting process, the backtesting processing includes cash processing, position processing, and order processing.

When the position processing is performed, since the price is already updated to the price after the company action, only the amount of shares and the cash need to be adjusted here. If a stock-split or stock-merger results in an adjusted amount that is not a whole lot or a whole share, cash in lieu may be generated, resulting in an increase in cash. When the price of a stock is too high, the company usually chooses to split the stock to reduce the stock price. After the stock-split, the shareholders' equity remains unchanged, the company's market value remains unchanged, and the stock price and the number of shares in circulation will change. When the price of a stock is too low, the company will consider to merge the stocks to increase the stock price. After the stock-merger, the shareholders' equity remains unchanged, the company's market value remains unchanged, and the stock price and the number of shares in circulation will change.

The forward adjusted number of shares=floor (the non-adjusted number of shares/forward adjustment factor A), where floor indicates a rounding down operation.

For example, it is assumed that there are originally 5 shares, and the company chooses to perform the stock-merger, with 3 shares merged into 1 share. For example, the original 5 shares of the original stock will become 1 share of the new stock and some cash in lieu which is the cash equivalent to 2 shares of the original stock.

When the cash processing is performed, the calculation formula for cash can be expressed as the following formula:

cash=cash+cash dividends in the current round+cash in lieu introduced in the current round of stock-split or stock-merger;

cash dividend=cash payout per share×the number of non-adjusted shares yesterday;

cash in lieu=the number of non-adjusted shares % forward adjustment factor A×the stock price before the company action;

where % represents the remainder operation, and % refers to the remainder after the preceding number (the number of non-adjusted shares) divided by the following number (the forward adjustment factor A).

When the order processing is performed, in order to make the order price comparable to the price in the real market, the price and amount adjustment is not performed for orders whose life cycles have ended.

For example, for a multi-day valid order whose life cycle has not ended, if a stock-split or a stock-merger occurs, a GTC order of the target is withdrawn; or if no stock-split or no stock-merger occurs and only dividend occurs, no withdrawal is performed. The GTC order is a valid order before withdrawal, which means that the order will remain valid in the market until a trader decides to withdraw the order.

In some embodiments, the method may further include: calculating, when the target trading strategy for performing the backtesting process includes a plurality of different target trading strategies, the backtesting data corresponding to the plurality of different target trading strategies independently, to generate a backtesting report corresponding to each of the plurality of different target trading strategies.

For example, the embodiments of the present disclosure support backtesting for a plurality of strategies of the same account at the same time. For example, each backtesting instance corresponds to a selected target trading strategy. Each backtesting instance has its own data space to store operation data of the backtesting instance. Each backtesting instance will have its own corresponding backtesting simulation exchange instance, and the backtesting data of each strategy backtesting instance is calculated independently to generate an independent backtesting report corresponding to each target trading strategy in the same backtesting cycle.

For example, when the strategy script is started, a backtesting ID for identifying the backtesting instance will be passed to the script, and the backtesting ID and the script will be connected and uploaded to a backtesting management module at a target client during an initialization stage of the script connection. The backtesting management module will bind the script connection to the backtesting instance having the backtesting ID, such that subsequent requests corresponding to the connection will be routed to the corresponding backtesting instance to identify the strategy script connection belongs to which backtesting instance (the target trading strategy). For example, if backtesting time elapses based on real time fixedly, e.g., the backtesting time elapses by 5 seconds every 5 milliseconds, the backtesting speed is limited. Thus, in the backtesting design according to the embodiments of the present disclosure, the time lapse process is performed cyclically, and the backtesting speed is determined based on the operating efficiency of the computer device used by the user, to control the speed of the real time and the backtesting time.

For example, when the strategy script completes a process, the backtesting management module is notified via a backtesting time protocol to control the lapse of trigger frequency time. For example, if the trigger frequency of the strategy script is 1 hour, and the backtesting time has been completed for 1 hour, but the execution of the script has not yet been completed, it will wait for the execution of the script to complete before continuing with a next time lapse process, so as to control all requests for the same process of the strategy script to be within the same operating cycle.

In some embodiments, the method may further include: storing, when obtaining the backtesting data corresponding to the target trading strategy, data change information for each backtesting time point in the backtesting data, and snapshot information corresponding to a predetermined backtesting time interval; and generating, when generating the backtesting report, the backtesting image in the backtesting report based on the data change information and the snapshot information.

For example, usually in the backtesting playing process, the snapshot information of a certain backtesting moment is displayed, such as asset information, an order position, etc. at the backtesting moment, and the snapshot data is needed. If snapshot information is stored at each progress point, and the backtesting time interval is relatively long, the storage space required will be very large. Therefore, in the actual implementation, the stored content at each progress point is the data change information, and the actual value at that time is calculated based on the time point of the progress point when the actual request is made.

For example, the initial value of the fund is 1000, and when the fund changes, the following records can be stored:
time point: 2021/11/18 00:00:00; change information: +100;
time point: 2021/11/18 00:10:00; change information: +200;
time point: 2021/11/18 00:20:00; change information: −100.

Taking the time and change information recorded above as an example, if the interface obtains the fund data at the backtesting time point of 2021/11/18 00:05:00, the obtained fund value is 1000+100=1100; if the interface obtains the fund data at the backtesting time point of 2021/11/18 00:15:00, the obtained fund value is 1000+100+200=1300.

For example, if only the change information is stored, the change calculation needs to be performed multiple times when it is required to obtain the snapshot information that is away from the start time of the backtesting. Therefore, in order to reduce the amount of calculation, snapshot information can be stored at every predetermined number (such as 50) of backtesting time points, such that when data is obtained at the target backtesting time point, the snapshot file can be calculated based on the snapshot information that is close to the target backtesting time point and change information, so as to achieve a balance between the calculation time and the storage space.

For example, the initial value of the fund is 1000, and when the fund changes, the following records can be stored:
time point: 2021/11/18 00:00:00; change information: +100;
time point: 2021/11/18 00:10:00; change information: +200;
time point: 2021/11/18 00:20:00; change information: −100; snapshot information: 1200;
time point: 2021/11/18 00:30:00; change information: −100;
time point: 2021/11/18 00:40:00; change information: +100.

Taking the time and change information recorded above as an example, if the interface obtains the fund data at the backtesting time point of 2021/11/18 00:35:00, the obtained fund is 1200−100=1100.

In some embodiments, the method may further include: generating, when generating the backtesting report, the backtesting image corresponding to the backtesting time in the backtesting report based on the backtesting data and a data type of the backtesting data, where: if the data type is incremental data, when the incremental data is updated in the backtesting image, only new data in the incremental data is drawn on the basis of original data; or if the data type is overwriting data, when the overwriting data is updated in the backtesting image, the original data is compared with the overwriting data, and a field having a data change in the overwriting data is drawn based on a result of the comparison.

For example, to reduce unnecessary drawing on the interface, incremental data can be drawn. For the incremental data, such as logs, asset curves and other data, when the incremental data is updated, new data can be added while retaining old data, the old data does not need to be redrawn, and only the new data part needs to be drawn. For the overwriting data, such as revenue overview, order transactions and other data, the new data and the old data may be compared with each other, and only the field having a data change needs to be updated. The scheme of comparing the data has less overhead of drawing.

In some embodiments, the obtaining of the playback data can be optimized. When playing slowly or playing back, the data to be drawn has been fully calculated. For the incremental data, when obtaining the data from the beginning to the current playing point each time, subsequent data from the current playing point needs to be obtained each time to reduce the overhead of frequently obtaining data.

At step 150, the backtesting image is displayed in the backtesting report dynamically based on the display interface.

For example, the front-end scheme in the embodiments of the present disclosure supports the form of a video player, for displaying visually historical orders, historical positions, historical trends, and asset curves. For example, in the embodiments of the present disclosure, when displaying the backtesting report, display and frame rate processing triggered by multi-targets at multi-frequency can be achieved.

In some embodiments, the backtesting report may include a plurality of backtesting images corresponding to the backtesting time. The operation of displaying the backtesting image in the backtesting report dynamically based on the display interface may include: playing the plurality of backtesting images in accordance with a progress bar based on a player in the display interface, where the progress bar includes a plurality of progress points each associated with corresponding backtesting data and a corresponding backtesting image.

For example, the embodiments of the present disclosure may provide a backtester of a quantitative component. The backtester may implement the trading strategy backtesting method according to the embodiments of the present disclosure. For example, the backtesting process can be made into a form of a player in the backtester. The backtesting report is played with the progress bar, which looks like the historical data being replayed at a higher speed, allowing the user to have a better visual experience.

For example, the principle of the player is to play the pictures formed of a plurality of sets of static data at a certain speed to form an animation effect. The progress bar, the formation of the trend diagram, and the display of other data will be described below.

In some embodiments, the method may further include, prior to playing the plurality of backtesting images in accordance with the progress bar: determining the plurality of progress points based on all predetermined operating frequencies corresponding to the target trading strategy and based on the backtesting time; and determining a playing speed of the progress bar corresponding to 1× speed based on the backtesting time and the plurality of progress points, and when the playing speed of the progress bar corresponds to a plurality of candidate speed levels, determining a current playing speed of the progress bar based on a currently selected target speed level and the playing speed of the progress bar corresponding to the 1× speed. The plurality of candidate speed levels include a maximum level and one or more levels other than the maximum level, and a playing speed corresponding to each of the one or more level is smaller than a backtesting calculation speed corresponding to the maximum level.

For example, referring to the progress bar illustrated in FIG. 4, the progress bar is composed of a plurality of progress points, and each progress point represents a data change node. By controlling a display progress of the progress bar, the data and pictures corresponding to the progress bar will be changed. For example, the progress points of the progress bar may be calculated based on the union of all operating frequencies, and the operating frequencies may be the frequencies set by the user in “backtesting parameter setting−target group−frequency” in the backtesting configuration interface 220 on the display interface 200 illustrated in FIG. 2.

For example, the user sets three “targets” in the backtesting parameter setting, and the operating frequencies corresponding to the respective “targets” are 3 minutes K, 5 minutes K, and 15 minutes K. At this time, the union of the frequencies of 3 minutes K, 5 minutes K, and 15 minutes K is displayed as the progress points of the progress bar. For example, in the progress bar illustrated in FIG. 4, if a backtesting interval is 35 minutes, the progress bar has round(35/3)+round(35/5)+round(35/15)=20 points (round means rounding down), i.e., 16 progress points after deduplication. Here, 3 minutes K means that the K-lines are divided into three equal parts, 5 minutes K means that the K-lines are divided into five equal parts, and 15 minutes K means that the K-lines are divided into fifteen equal parts.

For example, the playing speed of the progress bar can be divided into a plurality of levels: 0.5× speed, 1× speed, 2× speed, 5× speed, 10× speed, 100× speed, and a maximum level. The speed corresponding to the maximum level is the backtesting calculation speed of the backtester, and the backtesting calculation speed depends on the complexity of the strategy and the computing power of the computer. One or more levels other than the maximum level can include 0.5× speed, 1× speed, 2× speed, 5× speed, 10× speed, and 100× speed. For example, referring to the progress bar illustrated in FIG. 4, if the backtesting interval is 35 minutes, and the progress bar includes 16 progress points, then the progress bar moves to the next progress point every 0.5 second at the playing speed of 1× speed. The same also applies to the playing speeds of other levels. For example, if the selected level is 1× speed, the current playing speed of the progress bar means moving to the next progress point every 0.5 second, and the current playing speed is maintained when the K-line cycle changes.

For example, as illustrated in FIGS. 4 and 5, the progress bar is composed of a plurality of progress points. When the progress bar is dragged by the user, the progress bar is displayed in accordance with the illusion of continuity every second. In fact, the progress bar is composed of a plurality of discrete progress points, and in order not to make the user confused, in the embodiments of the present disclosure embodiment, the progress bar is made to have an illusion of smoothness, and the user can randomly place it at any point. Although the user can place the end of the progress bar at any point as desired, in fact, the information of the previous progress point will be displayed. For example, when the user drags to 4 minutes, the information of the time point at 3 minutes is displayed (such as the income overview, trend diagram, position list, equity curve, etc.). The playing speed between 4 minutes and 5 minutes can be obtained by scaling on the playing time based on a length between progress points proportionally.

For example, the video player may also display other data, including: income overview, equity curve, operation log, positions and orders, etc. The other data mentioned above change with the progress bar. Each progress point records a group of data of the above-mentioned modules, and when the progress bar passes each progress point, the data of the progress point is displayed until the next progress point is reached.

In some embodiments, the operation of determining the plurality of progress points based on all predetermined operating frequencies corresponding to the target trading strategy and based on the backtesting time may include: calculating a historical trading time period of each trading target based on historical K-line data corresponding to a base frequency; determining, based on all the predetermined operating frequencies corresponding to the target trading strategy, a time point to perform the target trading strategy each time in the historical trading time period of each trading target, where the base frequency is lower than each operating frequency; and integrating time points corresponding to all trading targets, and performing a sorting process and a deduplication process based on timestamps to obtain the progress points for the currently played progress bar.

Here, the backtesting exchange stores the data generated during the backtesting process, the playing management module controls the playing progress and continuously notifies the currently playing backtesting time to other controls for displaying information. The controls obtain the data and display it through the interface after receiving the time information. For example, during the backtesting process, different operating frequencies can be specified for a plurality of targets, and each operating frequency is used for executing the strategy once. The backtesting playing needs to display only the data after the strategy is executed each time, but not the data changes between executions of the strategy. The progress bar is actually composed of some discrete progress points (the time points at which the strategy is executed).

For example, the backtesting interval is 35 minutes, and progress points as illustrated in FIG. 4 are obtained by executions at a frequency of 3 minutes K, 5 minutes K, and 15 minutes K.

For example, the base frequency can be 1 minute K, and the progress points can be calculated in the following steps. The historical trading time period of each target is calculated from historical 1 minute K data as prepared in advance. Based on the operating frequency of the target set by the user, each time point to execute the target trading strategy is obtained in the historical trading time period obtained above. The time points of all the targets are integrated, and the sorting process and the deduplication process are performed based on the timestamps to obtain the progress points of the backtesting playing progress bar for this time.

In some embodiments, the method may further include, when playing the plurality of backtesting images in accordance with the progress bar: calculating a position of a refreshed progress bar each time based on the current playing speed of the progress bar, to achieve a smooth movement of the progress bar based on the position of the refreshed progress bar each time.

For example, a smoothing process can be performed on the progress bar. Since the progress bar is actually some discrete progress points, the progress bar may move every a few seconds, and jump over a distance each time, such that the visual experience is not smooth. Therefore, a smoothing logic process needs to be performed on the progress bar, such that the progress bar can move smoothly and coherently. The smoothing logic process may include increasing position refreshing frequency of the progress bar, such as refreshing every 100 milliseconds.

In some embodiments, the operation of calculating the position of the refreshed progress bar each time based on the current playing speed of the progress bar, to achieve the smooth movement of the progress bar based on the position of the refreshed progress bar each time may include: recording, when the current playing speed is the backtesting calculation speed corresponding to the maximum level, a calculation interval between every two time points, and determining average time consumption based on the calculation interval, and determining the position of the refreshed progress bar each time based on the average time consumption and a position interval between every two time points on the interface; or calculating, when the current playing speed is the target speed corresponding to any other level, an expected playing interval between every two time points based on the target speed, and calculating the position of the refreshed progress bar each time based on the expected playing interval and the position interval between every two time points on the interface.

For example, when the current playing speed follows the backtesting calculation speed, the calculation interval between every two time points is recorded, the average time consumption is recorded, and the position of the refreshed progress bar each time is calculated based on the average time consumption and the interface interval. For example, when the calculation interval between every two time points is 1 second, and the interval on the interface is 10 pixels, the progress bar will be refreshed to move 1 pixel each time.

For example, when the current playing speed is the speed corresponding to the slow speed level set by the user, the expected playing interval between every two time points is calculated based on the speed, and the position of the refreshed progress bar each time is calculated based on the expected playing interval and the interface interval.

The position of the refreshed progress bar each time is calculated to achieve the effect of the smooth movement of the progress bar and to provide a smooth and coherent visual effect. Although the data for other controls is refreshed based on the progress points, the progress bar has the visual effect of smooth movement.

In some embodiments, the operation playing the plurality of backtesting images in accordance with the progress bar may include: displaying, in response to a frequency switching instruction inputted by a user, a K-line corresponding to a target frequency in the frequency switching instruction in the backtesting image dynamically with a playing progress of the progress bar. The target frequency is a frequency selected from the operating frequencies.

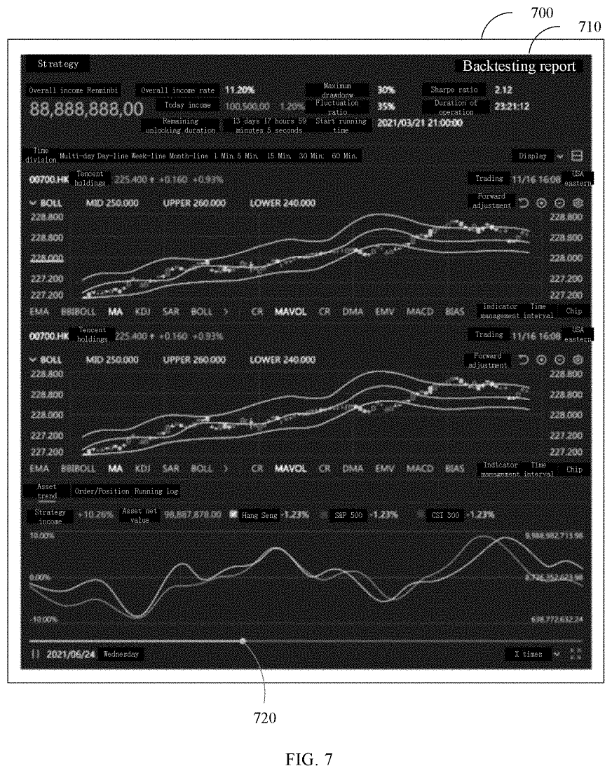

For example, the generated backtesting image may be a trend diagram. In response to the frequency switching instruction inputted by the user, the trend diagram is controlled to display the K lines corresponding to the frequency in accordance with the user's predetermined frequency. The generation rules of the trend diagram are linked with the playing of the progress bar and the trend diagram is dynamically generated with the playing progress. The generation rules of the trend diagram are displaying a corresponding K-line based on the selected frequency. If the K-line corresponding to the selected frequency includes a plurality of progress points (>1), at this time, the trend diagram as illustrated in FIG. 6 is dynamically generated. If the parameters selectable by the user include frequencies of 3 minutes K, 5 minutes K, and 15 minutes K, at this time there are 16 progress points after the deduplication process. If the display cycle is switched to 3 minutes K, the progress points having multiple of 3 (3 minutes, 6 minutes, 9 minutes . . . 33 minutes) and the last progress point (35 minutes) will be used to generate complete K-lines, including a total of 12 K-lines, of which the 2nd, 4th, 7th, and 9th K-lines will be used to dynamically generate a trend diagram as each of them includes a plurality of progress points.

In some embodiments, the operation of displaying the backtesting image in the backtesting report dynamically may include: playing back the backtesting image in the backtesting report dynamically in response to a playback instruction.

The front-end scheme of the current backtesting system does not support backtracking, and if the user wants to review the order position at a backtesting time point, the backtesting process needs to be performed again (which is highly time-consuming and inefficient), or the order position needs to be looked for in the complex order list after the backtesting process (it is difficult to reproduce the scene at that time). In the embodiments of the present disclosure, the playback function of the backtesting is supported. When the backtesting progress is interrupted or the backtesting progress is resumed, the backtesting information is stored in the local terminal. In response to the playback instruction, the backtesting image in the backtesting report can be dynamically played back by invoking the backtesting information stored in the local terminal.

In some embodiments, the method may further include: when playing a plurality of backtesting images in accordance with the progress bar, refreshing backtesting data corresponding to the plurality of backtesting images, and controlling the number of times of data refreshing per second.

For example, the backtesting data corresponding to the backtesting image is constantly refreshed to achieve the effect of dynamic playing, and the number of times of data refreshing per second is controlled to achieve a balance between the playing experience and the use of resources.

For example, if the current playing speed follows the backtesting calculation speed, there are a relatively large number of progress points, and the data at each progress point is refreshed, a relatively large amount of computer resources will be consumed, and the user cannot visually recognize the changes with the data refreshing. As a result, the maximum data refreshing frequency can be limited to reduce the overhead of drawing the backtesting image and to ensure a visual experience for the user. For example, the data refreshed every two times may be spaced multiple progress points apart.

In some embodiments, the playing speed may be controlled.

For example, when the current playing speed follows the backtesting calculation speed, the playing management module will receive a backtesting calculation progress message of the backtesting exchange, and notify the current backtesting time as the playing time point to the interface control.

For example, when the current playing speed is the slow speed level set by the user or the speed corresponding to playback, a timer can be started to calculate the expected playing interval for each progress point based on the corresponding speed set by the user, and the interface control can be notified when the timing message meets the playing interval for the progress point.

For example, in a player interface 700 illustrated in FIG. 7, the backtesting image in the backtesting report 710 is dynamically played with the progress bar 720. The player interface 700 can display the backtesting image, the profit situation, the asset trend, the position list, the list of historical orders, the operation log and the like related to the backtesting report. The player interface can also display various types of selection buttons, such as a selection button for selecting currency, a selection button for selecting operating frequency, a selection button for selecting speed level, a selection button for selecting display content, etc.

For example, in order to give the user a complete picture of the overall strategy, the backtesting report can be analyzed from three different dimensions: income risk correlation, position correlation, and attribution analysis. The user can combine three different dimensions to analyze the profitability of the strategy, the ability to combat risks of the strategy, and the attribution of profitability and risk of the strategy.

The income risk correlation mainly displays the quantitative indicators and income related diagrams in the strategy backtesting period, which is convenient for the user to determine the performance of the strategy based on the quantitative indicators. The income risk correlation content includes: income indicators, risk indicators, net value curves, daily profits and losses, daily buying and selling, maximum drawdown diagrams, profit and loss calendars, individual stock profit and loss heat map, etc. In the embodiments of the disclosure, each curve (net value curve, daily profit and loss, daily buying and selling, maximum drawdown diagram) is aligned with the timeline, and the user can compare the incomes, risks, positions, orders and other information of the strategy at the same moment, to the greatest extent to reproduce the performance of the strategy at that moment. At the same time, the income indicators and risk indicators here involve the selection of benchmarks, and different types of strategies correspond to different benchmarks for calculation.

The position correlation is to display the strategy historical positions and orders in a form of a list, which is convenient for the user to trace back to find historical orders and to find the direct causes of making money and losing money. At the same time, the quantitative component will also analyze the positions and provide a distribution chart or pie graph for the user's reference, including: asset distribution, target distribution, position list, historical order list, etc. The user can intuitively figure out the distribution of assets and the distribution of targets in a certain time section based on the pie graph, and intuitively analyze the style of the strategy, such that the user can have a deeper understanding of the strategy in the position dimension.

The attribution analysis focuses on explaining the performance of the strategy from the perspective of the model, which helps the user analyze the reasons for making money and losing money in the strategy and find the direction of optimization. Different analytical models are given based on different types of strategies. Common models include: Brinson model, etc. Model for analyzing stock strategies includes: Fama-French model, Barra model, etc. The Brinson model is divided into single-period and multi-period, and the quantitative component analyzes the strategy based on the multi-period Brinson model, can divide the income of the portfolio into asset allocation income, individual stock selection income, interactive income, and benchmark income and divide the risk of the portfolio into asset allocation risk, individual stock selection risk, interaction risk, and benchmark risk, and can explain the income and risk sources from the perspective of weight allocation and asset selection, respectively. The Fama-French model and the Barra model are used to analyze stock strategies. The Fama-French model decomposes the income into three aspects: market factor, value factor, market capitalization factor, and analyzes the investment style of the strategy based on the size of the exposure. Multiple regression is performed on the established factor exposure of stocks in the whole market to determine the factor income rate of style factors and industry factors. Then the daily income of the portfolio is obtained using the multi-factor income attribution model, and the exposure extent of the portfolio to various factors can be observed, and the income and risk analysis of the portfolio can be carried out from the perspective of various factors.

In a typical backtesting report, a single benchmark is always used to calculate the income or risk indicators, which leads to a mismatch between the benchmark and the strategy. Because the quantitative component of the strategy contains a variable category, which may be stocks, options, futures and other categories, how to more scientifically select the benchmark and calculate has become a major problem. Based on this, the quantitative component offers three solutions below for the user to choose.

(1) The commonly used benchmarks can be extended. The user can switch the benchmarks, and the corresponding indicators and diagrams change. The benchmarks include the indexes shown in Table 1 below based on different market classifications.

TABLE 1

| Market | Index as benchmark |
|---|---|
| Hong | Hang Seng Index, State-Owned Enterprises Index |
| Kong | |
| United | NASDAQ Composite Index, S&P 500 Index, |
| States | Dow Jones Industrial Index |
| A-share | CSI 300, Shanghai Composite Index, Shenzhen Index |
| Singapore | FTSE Singapore Straits Index, FTSE Straits All Stock Index |
| Japan | Nikkei |

(2) The user can search and select a benchmark. The user uses a searched specific target or index as the benchmark.

(3) The user constructs a benchmark. The benchmark can be constructed from weighted indices or targets. For example, a user's strategy includes trading U.S. and Hong Kong stocks, and the 50% Hang Seng Index and the 50% S&P 500 Index can be used as benchmarks. The weighting proportion can be set freely by the user, and the weighted target or index is also set by the user.

In some embodiments, a strategy script of the target trading strategy verified by backtesting can be obtained, and the strategy script of the target trading strategy can be executed based on real-time trading data to generate trading instructions. The trading instructions are for indicating trading operations. For example, the trading instructions contain necessary elements for the trading, such as buying/selling, target trading target, buying/selling price, and trading shares. After generating the trading instructions, the trading instructions are output to the corresponding exchange for trading.

In order to better implement the trading strategy backtesting method according to the embodiments of the present disclosure, the embodiments of the present disclosure may provide a backtester. Referring to the schematic diagram of the framework of the backtester illustrated in FIG. 8, the backtester may include a backtesting management module 810, a backtesting exchange 820 and a script management module 830.

The backtesting management module 810 is for backtesting management. The backtesting management module 810 is responsible for regulating the backtesting process, integrating backtesting data, providing a complete functional interface for the display interface, and is the middle layer between the backtesting data and the display interface, and has the role of intermediation between upper and lower levels.

For example, the backtesting management module 810 may include a backtesting configuration module 811, a trading data module 812, a first log data module 813, a backtesting information storage module 814, a backtesting process management module 815, a playing management module 816, a first data module 817, etc.

For example, the steps 110 to 150 as illustrated in FIG. 1 may be implemented by invoking the backtesting management module 810, the backtesting exchange 820 and the script management module 830.

The functional interface request in the backtesting management module 810 will be distributed to the following sub-modules for processing.

The backtesting configuration module 811 is a data access module for user-configured backtesting configuration information, and the backtesting configuration information is used for interface display or backtesting control. For example, before performing the step 130 (obtaining the backtesting data corresponding to the target trading strategy) as described in FIG. 1, the backtesting configuration module 811 may be invoked to configure the backtesting configuration information.

The trading data module 812 is configured to only transfer the trading data request interface in the backtesting exchange 820, and the actual trading data is stored in the backtesting exchange 820. The trading data request interface may include a position information interface, an order information interface, an income rate interface, an income indicator interface, an order transaction dot data interface, and the like. The time-related interface may include the position information interface, the order information interface, the order transaction data interface, etc., and the interfaces related to currency, time point and so on may include the income rate interface and the income indicator interface.

The user uses the backtesting function to understand the operating situation of the current strategy through the strategy script operation log. The first log data module 813 is configured to only transfer the log request interface in the backtesting exchange 820, and the actual log data is stored in the backtesting exchange 820.

The backtesting information storage module 814 is configured to support backtesting playback, and store the backtesting information to the local terminal when the backtesting progress is interrupted or the backtesting progress is resumed. The backtesting information that needs to be saved includes all the logs, order position data, etc. that are generated during the entire backtesting period (further examples will be omitted here). The backtesting information storage module is only responsible for managing the storage and loading timing, and the module corresponding to data that needs to be stored provides serialized data and loads data interfaces.

The backtesting process management module 815 is configured to regulate other sub-module functions to complete the preliminary preparation of the strategy backtesting operation, which includes: (1) triggering creation of backtesting trading account, reading the capital configuration related fields in the backtesting configuration module, and creating a trading account for the backtesting in the backtesting exchange 820 (e.g., the backtesting ID, strategy ID, account ID, and target information are obtained by invoking a script to start an interface; (2) downloading historical data, reading the target that the user needs to use in the strategy, comparing the existing price information in the local data storage module to find out the target market that needs to be downloaded, continuing with transfer of the download progress, and feeding back the download progress to the interface; and (3) after the historical data is prepared, loading the python script generated by the backtesting strategy to the script management module 830, and starting the backtesting strategy script.

The playing management module 816 is configured to display in the form of video playing during the backtesting process, and has fast forward, fallback, pause, acceleration and other playing functions. The playing management module 816 is responsible for implementation of the logic of these playing functions.

The backtesting exchange 820 is responsible for the actual operation regulation of the backtesting, and the generation and management of the backtesting data. The backtesting data includes backtesting asset change information, order status change, backtesting index calculation, etc.

For example, the backtesting exchange 820 may include a backtesting calculation management module 821, a backtesting trading module 822, a backtesting market module 823, a second log data module 824, an initialization protocol module 825, a service protocol module 826, a log protocol module 827, a backtesting time protocol module 828, etc.

For example, the backtesting trading module 822 may include a trading matching module 8221, a fee module 8222, a backtesting account module 8223, a backtesting trading service protocol processing module 8224, etc.

For example, the backtesting market module 823 may include a data download module 8231, a data storage module 8232, a second data module 8233, a backtesting market service protocol processing module 8234, etc.

The functional interface request of the backtesting exchange 820 will be distributed to the following sub-modules for processing.

In the backtesting calculation management module 821, the strategy script will complete all processes within the trigger frequency of the target during the backtesting process. Therefore, a mechanism is needed to synchronize and maintain the lapse of the backtesting time through the backtesting calculation management module 821 for the backtesting management module 810 and the strategy script. The backtesting exchange 820 provides an OnTime callback interface for market and trading, which is invoked by the independent thread of the backtesting management module 810 circularly. The backtesting time elapses at intervals of 5 seconds (s) in intraday time and the backtesting time elapses at intervals of 1 hour (h) in non-intraday time. The strategy script completes the process once, and notifies the backtesting management module 810 through the backtesting time protocol module 828 to control the lapse of the triggering frequency time in intraday time. For example, if the triggering frequency of the strategy script is 1 h, and 1 h of the backtesting time has elapsed, but the execution of the script has not been completed, then it will wait for the execution of the script to complete before continue with the next OnTime callback interface. At the same time, the backtesting calculation management module 821 notifies the progress of the backtesting calculation, e.g., by sending the backtesting time notification to the backtesting trading module 822 or the second data module 8233 in the backtesting market module 823.

The backtesting calculation management module 821 can further be configured to record backtesting calculation related information, such as the mapping relation between the script connection ID and the backtesting ID, the mapping relation between the backtesting ID and the backtesting account ID, and the backtesting start interval, and to determine which backtesting instance the backtesting request originates from.

The second log data module 824 is configured to notify the log data generated by the strategy script to the target client process through a channel. The second log data module 824 is responsible for managing all the log data generated by the script, including data from real market and backtesting, and identify to which real market or backtesting instance the log data belongs based on the script connection identification.

The backtesting market module 823 is responsible for downloading, storing, generating, obtaining and other processing of historical market data.

The downloading processing means that the historical K-lines, adjustment information and other data required for backtesting can be downloaded through the data download module 8231 in the backtesting market module 8231.

The storing processing means that the data can be encrypted, compressed, and stored to the local terminal through the data storage module 8232 in the backtesting market module 823, reducing the downloading cost of multiple backtestings for the same data.

The generating processing means that partially unsupported historical data is generated, such as historical data one by one, and a simulated data of this branch one by one is constructed from historical 1 minute K.

The obtaining processing means that through the second data module 8233 in the backtesting market module 823, based on the backtesting market information protocol service request of the backtesting market service protocol processing module 8234, the backtesting market information is pushed to the backtesting market service protocol processing module 8234; or based on the market data request sent by the trading matching module 8221, the trading matching module 8221 is provided with data, etc.

For example, the second data module 8233 may also provide company market information for the backtesting account module 8223.

For example, the backtesting market module 823 is further configured to read the market information of the target used in the strategy, trigger the download of historical data, and transfer the download progress to the interface based on the received market data request.

The backtesting trading module 822 of the backtesting exchange 820 is configured to manage data such as account orders and match orders through historical market information.

The fee module 8222 is configured to calculate platform fees, commission fees, interest, and record the deduction history.

The backtesting account module 8223 can be configured to receive the created backtesting account information; and it can further be configured to manage the positions, assets, orders, transaction data and other information corresponding to the backtesting account; and it can further be configured to manage the order operation, order status and other information provided by the trading matching module 8221.

The initialization protocol module 825 is configured to perform the script connection initialization on the strategy script, where the script connection carries the backtesting identification (ID), and upload the backtesting ID and the script connection to the backtesting management module 820 of the target client in the script connection initialization stage.

In the service protocol module 826, during the operation of the strategy script, the strategy script will communicate data with the target client through the service protocol module 826, and obtain market data or target data for trading operations. When the strategy script does not know whether the target data is backtesting data or real market data, the determination logic here is done in the service processing of the target client. In each service protocol module of the target client, which connection the protocol originates from is determined to determine the target connection corresponding to the protocol, and based on the determined target connection, the target backtesting instance corresponding to the target connection is found out in the backtesting information module (not shown in the figure), and the target data is requested in the data module corresponding to the target backtesting instance. If it is not a backtesting instance, the processing process will go to the real service processing logic and send trading instructions or request data to the target background corresponding to the target client. The target backtesting instance is the target trading strategy selected from the created trading strategy.

The log protocol module 827 is configured to obtain log data from the backtesting management module 10 based on time.

The backtesting time protocol module 828 is configured to notify the backtesting management module 810 through the backtesting time protocol module 828 when the strategy script completes the process once, to control the lapse of the trigger frequency time in the intraday time.

For example, in the schematic flowchart of the backtesting operation as illustrated in FIG. 9, the target client is configured with the backtester of the quantitative component. When the backtesting process is performed, the backtesting process mainly has the following stages.

(1) Data Preparation Stage.

At step 901, the historical data is downloaded and the historical data is generated.

At step 902, the strategy script is started, and the script connection is associated with the backtesting instance by creating the backtesting connection.

(2) Strategy Execution Stage:

At step 903, the backtester is started.

At step 904, the historical data is read circularly.

At step 905, the strategy script waits for the data to be pushed to promote the operation of the event-driven strategy core logic. That is, the strategy script receives the pushed historical data to trigger the strategy logic execution, and sends the completion notification to the target client after execution.

At step 906, the backtesting time begins to elapse rapidly, and the K-line data corresponding to the backtesting time is generated and pushed to the strategy script.

At step 907, after the backtesting ends, the end-of-backtesting notification is sent to the strategy script to exit the strategy script based on the end-of-backtesting notification.

(3) Backtesting Data Statistics Stage:

At step 908, after the backtesting ends, the asset analysis of the backtesting data is carried out to organize the backtesting data into the backtesting report.

At step 909, the backtesting report is displayed.

For example, in the schematic diagram of the result displaying process as illustrated in FIG. 10, the playing management module may include the following steps, when displaying the backtesting report based on the backtesting playing time.

At step 1001, the time point of backtesting playing that exceeds the highest refreshing frequency is filtered out on the backtesting interface.

At step 1002, the time point is notified to each sub-control, such that each control obtains data from the data module based on the time point and draws on the interface.

At step 1003, the data type of the requested data is determined. When the data type is overwriting data, step 1004 is performed; or when the data type is incremental data, step 1005 is performed.

At step 1004, each sub-control determines whether the control contains the data corresponding to the time point. If the control does not contain the data corresponding to the time point, step 1005 is performed; or if the control contains the data corresponding to the backtesting time point, step 1006 is performed.

At step 1005, the sub-control requests data based on this time point to obtain the backtesting data from the backtesting management module.

At step 1006, the data change is compared to find out the data that has changed.

At step 1007, the interface is drawn.

All of the above technical solutions may be arbitrarily combined to form an optional embodiment of the present disclosure, which will not be repeated here.

In the embodiments of the present disclosure, a display interface with a graphical function interface is provided. The display interface is configured to provide a display interface for a trading strategy and an editing interface for a trading strategy element. In response to a strategy editing operation for the editing interface, a target trading strategy is generated, and the target trading strategy is converted into a corresponding strategy script. The target trading strategy includes a strategy condition for at least one of cross-market, cross-category, and cross-cycle. Backtesting data corresponding to the target trading strategy is obtained. A backtesting process is performed on the target trading strategy based on the backtesting data and the strategy script to generate a backtesting report. The backtesting report includes a backtesting image corresponding to backtesting time. Based on the display interface, the backtesting image in the backtesting report is displayed dynamically. In the embodiments of the present disclosure, the display interface with the graphical functional interface can be used to achieve the construction of the trading strategy and achieve a strategy backtesting method for at least one of cross-market, cross-category, and cross-cycle, so as to improve the effectiveness and accuracy of the strategy, dynamically display the backtesting report, and improve the display effect. In the embodiments of the present disclosure, the form of a video player is supported and can be used to display the backtesting report visually. When displaying the backtesting report, display and frame rate processing triggered by multi-target multi-frequency can be achieved. The historical company actions may be performed by means of dynamic forward adjustment to reproduce historical real stock-split or stock-merger and dividend, and to avoid future data.

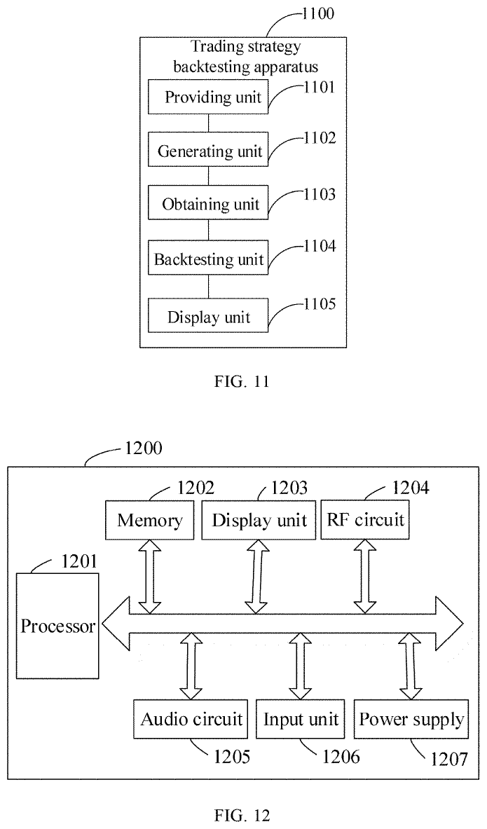

In order to facilitate better implementation of the trading strategy backtesting method according to the embodiments of the present disclosure, the embodiments of the present disclosure provide a trading strategy backtesting apparatus. Referring to FIG. 11, FIG. 11 is a schematic structural diagram of a trading strategy backtesting apparatus according to an embodiment of the present disclosure. The trading strategy backtesting apparatus 1100 is applied to a terminal device with a graphical user interface. The trading strategy backtesting apparatus 1100 may include:

a providing unit 1101 configured to provide a display interface with a graphical function interface, where the display interface is configured to provide a display interface for a trading strategy and an editing interface for a trading strategy element;

a generating unit 1102 configured to generate a target trading strategy in response to a strategy editing operation for the editing interface, and convert the target trading strategy into a corresponding strategy script, where the target trading strategy includes a strategy condition for at least one of cross-market, cross-category, and cross-cycle;

an obtaining unit 1103 configured to obtain backtesting data corresponding to the target trading strategy;

a backtesting unit 1104 configured to perform a backtesting process on the target trading strategy based on the backtesting data and the strategy script to generate a backtesting report, where the backtesting report includes a backtesting image corresponding to backtesting time; and

a display unit 1105 configured to display the backtesting image in the backtesting report dynamically based on the display interface.

In some embodiments, when the target trading strategy includes the strategy condition for cross-market, the obtained backtesting data may include historical data corresponding to a trading target in different markets. The backtesting unit 1104 may be configured to: determine a virtual account with a single-currency deposit among at least one virtual account corresponding to a target user as the target account; and determine, during the backtesting process, when a first currency as a denomination currency for the trading target and a second currency as a deposit currency in the target account are inconsistent, an amount in the second currency corresponding to the denomination currency for the trading target based on a historical exchange rate between the first currency and the second currency, and perform the backtesting process on the target trading strategy based on the amount in the second currency corresponding to the denomination currency of the trading target to generate the backtesting report for characterizing the cross-market.

In some embodiments, when the target trading strategy includes the strategy condition for cross-category, the obtained backtesting data may include historical data corresponding to trading targets in different categories. The backtesting unit 1104 may be configured to: obtain historical K-line data corresponding to all trading targets in the backtesting data, and mark time information of the historical K-line data based on timestamps; and manage, during the backtesting process, a backtesting progress based on the timestamps, to generate the backtesting report for characterizing the cross-category based on different time intervals and the time information of the historical K-line data.

In some embodiments, when the target trading strategy includes the strategy condition for cross-cycle, the obtained backtesting data may include historical data corresponding to a trading target in different cycles. The backtesting unit 1104 may be configured to: obtain historical K-line data corresponding to the trading target in different cycles in the backtesting data; and re-aggregate, during the backtesting process, when a K-line in first historical K-line data corresponding to a first cycle in the different cycles has not ended, for generating the backtesting image, a K-line corresponding to the first historical K-line data based on a predetermined cycle and the first historical K-line data corresponding to the first cycle, to generate the backtesting report for characterizing the cross-cycle, where a time length of the first cycle is greater than a time length of the predetermined cycle.

In some embodiments, when the target trading strategy includes the strategy conditions for cross-market and cross-category, the obtained backtesting data may include historical data corresponding to trading targets in different markets and different categories. The backtesting unit 1104 may be configured to: determine a virtual account with a single-currency deposit among at least one virtual account corresponding to a target user as a target account; determine, when a first currency as a denomination currency of the trading targets and a second currency as a deposit currency in the target account are inconsistent, an amount in the second currency corresponding to the denomination currency for the trading targets based on a historical exchange rate between the first currency and the second currency; obtain historical K-line data corresponding to all trading targets in the backtesting data, and mark time information of the historical K-line data based on timestamps; and manage, during the backtesting process, a backtesting progress based on the timestamps, to perform the backtesting process on the target trading strategy, based on different time intervals, the time information of the historical K-line data, and the amount in the second currency corresponding to the denomination currency for the trading targets, to generate the backtesting report for characterizing the cross-market and the cross-category.

In some embodiments, when the target trading strategy includes the strategy conditions for cross-market and cross-cycle, the obtained backtesting data may include historical data corresponding to trading targets in different markets and different cycles. The backtesting unit 1104 may be configured to: determine a virtual account with a single-currency deposit among at least one virtual account corresponding to a target user as a target account; determine, when a first currency as a denomination currency for the trading targets and a second currency as a deposit currency in the target account are inconsistent, an amount in the second currency corresponding to the denomination currency for the trading targets based on a historical exchange rate between the first currency and the second currency; obtain historical K-line corresponding to all trading targets in the backtesting data; re-aggregate, when a K-line in first historical K-line data corresponding to a first cycle in the different cycles has not ended, a K-line corresponding to the first historical K-line data based on a predetermined cycle and the first historical K-line data corresponding to the first cycle, where a time length of the first cycle is greater than a time length of the predetermined cycle; and perform the backtesting process on the target trading strategy based on the amount in the second currency corresponding to the denomination for the trading targets, and the re-aggregated K-line corresponding to the first historical K-line data, to generate the backtesting report for characterizing the cross-market and the cross-cycle.

In some embodiments, when the target trading strategy includes the strategy conditions for cross-market, cross-category, and cross-cycle, the obtained backtesting data may include historical data corresponding to trading targets in different markets, different categories, and different cycles. The backtesting unit 1104 may be configured to: determine a virtual account with a single-currency deposit among at least one virtual account corresponding to a target user as a target account; determine, when a first currency as a denomination currency for the trading targets and a second currency as a deposit currency in the target account are inconsistent, an amount in the second currency corresponding to the denomination currency for the trading targets based on a historical exchange rate between the first currency and the second currency; obtain historical K-line data corresponding to all trading targets in the backtesting data, and mark time information of the historical K-line data based on timestamps; re-aggregate, when a K-line in first historical K-line data corresponding to a first cycle in different cycles has not ended, a K-line corresponding to the first historical K-line data based on a predetermined cycle and the first historical K-line data corresponding to the first cycle, where a time length of the first cycle is greater than a time length of the predetermined cycle; and manage, during the backtesting process, a backtesting progress based on the timestamps, to perform the backtesting process on the target trading strategy, based on different time intervals, the time information of the historical K-line data, the amount in the second currency corresponding to the denomination currency for the trading targets, and the re-aggregated K-line corresponding to the first historical K-line data, to generate the backtesting report for characterizing the cross-market, the cross-category, and the cross-cycle.

In some embodiments, the backtesting unit 1104 may further be configured to: perform, when the backtesting processing includes at least one of position processing, cash processing, and order processing, the backtesting process by means of dynamic forward adjustment. The dynamic forward adjustment is to trigger forward adjustment once for all data before a current moment whenever at least one of stock-split, stock-merger, and dividend occurs for a target company in the backtesting data.

In some embodiments, the backtesting report may include a plurality of backtesting images corresponding to the backtesting time, and the display unit 1105 may be configured to: play the plurality of backtesting images in accordance with a progress bar based on a player in the display interface. The progress bar includes a plurality of progress points each associated with corresponding backtesting data and a corresponding backtesting image.

In some embodiments, the display unit 1105 may be configured to, prior to playing the plurality of backtesting images in accordance with the progress bar: determine the plurality of progress points based on all predetermined operating frequencies corresponding to the target trading strategy and based on the backtesting time; and determine a playing speed of the progress bar corresponding to 1× speed based on the backtesting time and the plurality of progress points, and when the playing speed of the progress bar corresponds to a plurality of candidate speed levels, determine a current playing speed of the progress bar based on a currently selected target speed level and the playing speed of the progress bar corresponding to the 1× speed. The plurality of candidate speed levels include a maximum level and one or more levels other than the maximum level, and a playing speed corresponding to each of the one or more levels is smaller than a backtesting calculation speed corresponding to the maximum level.

In some embodiments, the display unit 1105 may be configured to, when determining the plurality of progress points based on all predetermined operating frequencies corresponding to the target trading strategy and based on the backtesting time: calculate a historical trading time period of each trading target based on historical K-line data corresponding to a base frequency; determine, based on all predetermined operating frequencies corresponding to the target trading strategy, a time point to perform the target trading strategy each time in the historical trading time period of each trading target, where the base frequency is lower than each operating frequency; and integrate time points corresponding to all trading targets, and performing a sorting process and a deduplication process based on timestamps to obtain the progress points for the currently playing progress bar.

In some embodiments, the display unit 1105 may further be configured to, when playing the plurality of backtesting images in accordance with the progress bar: calculate a position of a refreshed progress bar each time based on the current playing speed of the progress bar, to achieve a smooth movement of the progress bar based on the position of the refreshed progress bar each time.

In some embodiments, the display unit 1105 may be configured to, when calculating the position of the refreshed progress bar each time based on the current playing speed of the progress bar, to achieve the smooth movement of the progress bar based on the position of the refreshed progress bar each time: record, when the current playing speed is the backtesting calculation speed corresponding to the maximum level, a calculation interval between every two time points, and determine average time consumption based on the calculation interval, and determine the position of the refreshed progress bar each time based on the average time consumption and a position interval between every two time points on the interface; or calculate, when the current playing speed is the target speed corresponding to any other level, an expected playing interval between every two time points based on the target speed, and calculate the position of the refreshed progress bar each time based on the expected playing interval and the position interval between every two time points on the interface.

In some embodiments, the display unit 1105 is further configured to, when playing the plurality of backtesting images in accordance with the progress bar: display, in response to a frequency switching instruction inputted by a user, a K-line corresponding to a target frequency in the frequency switching instruction in the backtesting image dynamically with a playing progress of the progress bar, where the target frequency is a frequency selected from the operating frequencies.

In some embodiments, the backtesting unit 1104 may be configured to: calculate, when the target trading strategy for performing the backtesting process includes a plurality of different target trading strategies, the backtesting data corresponding to the plurality of different target trading strategies independently, to generate a backtesting report corresponding to each of the plurality of different target trading strategies.

In some embodiments, the obtaining unit 1103 may further be configured to store, when obtaining the backtesting data corresponding to the target trading strategy, data change information for each backtesting time point in the backtesting data, and snapshot information corresponding to a predetermined backtesting time interval; and the backtesting unit 1104 may further be configured to generate, when generating the backtesting report, the backtesting image in the backtesting report based on the data change information and the snapshot information.

In some embodiments, the backtesting unit 1104 may further be configured to: generate, when generating the backtesting report, the backtesting image corresponding to the backtesting report based on the backtesting data and a data type of the backtesting data, where: if the data type is incremental data, when the incremental data is updated in the backtesting image, only new data in the incremental data is drawn on the basis of original data; or if the data type is overwriting data, when the overwriting data is updated in the backtesting image, the original data is compared with the overwriting data, and a field having a data change in the overwriting data is drawn based on a result of the comparison.

In some embodiments, the display unit 1105 may further be configured to play back the backtesting image in the backtesting report dynamically in response to a playback instruction.

In some embodiments, the display unit 1105 may further be configured to: when playing the plurality of backtesting images in accordance with the progress bar, refresh backtesting data corresponding to the plurality of backtesting image, and control the number of times of data refreshing per second.

All of the above technical solutions may be arbitrarily combined to form an optional embodiment of the present disclosure, which will not be repeated here.

It should be understood that the apparatus embodiments and the method embodiments may correspond to each other, similar descriptions may refer to the method embodiments. To avoid duplication, the description will not be repeated here. Specifically, the apparatus illustrated in FIG. 11 may perform the above-described trading strategy backtesting method embodiments, and the foregoing and other operations and/or functions of each unit in the apparatuses implements respectively the corresponding process of the above method embodiments, which will not be repeated here for simplicity.

Accordingly, the embodiments of the present disclosure provide a terminal device, and the terminal device may be a terminal or a server. The terminal may be a smart phone, a tablet computer, a laptop, a smart TV, a smart speaker, a wearable smart device, a personal computer and other device. As illustrated in FIG. 12, FIG. 12 is a schematic structural diagram of a terminal apparatus according to an embodiment of the present disclosure. The terminal apparatus 1200 includes a processor 1201 having one or more processing cores, a memory 1202 having one or more computer-readable storage media and a computer program stored on the memory 1202 and executable on the processor. The processor 1201 is electrically connected to the memory 1202. Those skilled in the art will appreciate that the terminal apparatus structure illustrated in the drawing does not constitute a limitation of the terminal apparatus, and may include more or fewer components than illustrated, or a combination of certain components, or different arrangements of components.

The processor 1201 is a control center of the terminal device 1200, which uses various interfaces and lines to connect various parts of the entire terminal device 1200, and by running or loading software programs and/or modules stored in the memory 1202, and calling data stored in the memory 1202, performs various functions of the terminal device 1200 and processes data, thereby monitoring the terminal device 1200 as a whole.

In the embodiments of the present disclosure, the processor 1201 of the terminal device 1200 will follow the following steps, load instructions corresponding to a process of one or more applications into the memory 1202, and the processor 1201 executes the application stored in the memory 1202, thereby implementing various functions including: providing a display interface with a graphical function interface, where the display interface is configured to provide a display interface for a trading strategy and an editing interface for a trading strategy element; generating a target trading strategy in response to a strategy editing operation for the editing interface, and converting the target trading strategy into a corresponding strategy script, where the target trading strategy includes a strategy condition for at least one of cross-market, cross-category, and cross-cycle; obtaining backtesting data corresponding to the target trading strategy; performing a backtesting process on the target trading strategy based on the backtesting data and the strategy script to generate a backtesting report, where the backtesting report includes a backtesting image corresponding to backtesting time; and displaying the backtesting image in the backtesting report dynamically based on the display interface.

The specific implementation of each of the above operations may refer to the previous embodiments, which will not be repeated here.

In some embodiments, as illustrated in FIG. 12, the terminal device 1200 further includes: a display unit 1203, an RF circuit 1204, an audio circuit 1205, an input unit 1206, and a power supply 1207. The processor 1201 is connected to the display unit 1203, the RF circuit 1204, the audio circuit 1205, the input unit 1206, and the power supply 1207 electrically. Those skilled in the art will appreciate that the terminal apparatus structure illustrated in FIG. 12 does not constitute a limitation of the terminal apparatus, and may include more or fewer components than illustrated, or a combination of certain components, or different arrangements of components.

The display unit 1203 may be configured to display information inputted by the user or information provided to the user and various graphical user interfaces of the terminal device. These graphical user interfaces may be composed of graphics, text, icons, videos and any combination thereof. The display unit 1203 may include a display panel and a touch panel.

The RF circuit 1204 may be configured to transmit and receive radio frequency signals, to establish wireless communication with network device or other terminal device through wireless communication, and to transmit and receive signals with the network device or other terminal device.

The audio circuit 1205 may be configured to provide an audio interface between the user and the terminal device through speakers, microphones.

The input unit 1206 may be configured to receive inputted numbers, character information or user characteristic information (e.g., fingerprint, iris, face information, etc.), and generate keyboard, mouse, joystick, optical or trackball signal input related to user setting and functional control.

The power supply 1207 is configured to power the various components of the terminal device 1200. In some embodiments, the power supply 1207 may be connected to the processor 1201 logically by a power management system, thereby managing charging, discharging, and power management function through the power management system. The power supply 1207 may further include one or more DC or AC power supply, recharge systems, power failure detection circuits, power converters or inverters, power supply status indicators and any other component.

Although not shown in FIG. 12, the terminal device 1200 may also include a camera, a sensor, a wireless fidelity module, a Bluetooth module, etc., which will not be repeated here.

The specific implementation of each of the above operations may refer to the previous embodiments, which will not be repeated here.

Those of ordinary skill in the art will appreciate that all or some of the steps in the various methods of the above embodiments may be implemented by instructions, or by related hardware controlled by instructions, and the instructions may be stored in a computer-readable storage medium, and loaded and executed by the processor.

To this end, the embodiments of the present disclosure provide a computer-readable storage medium having a plurality of computer programs stored thereon. The computer programs can be loaded by the processor to perform the steps in the trading strategy backtesting method according to any one of the embodiments of the present disclosure. The specific implementation of each of the above operations may refer to the previous embodiments, which will not be repeated here.

The storage medium may include: a read only memory (ROM), a random access memory (RAM), a disk or an optical disk and the like.

Since the computer programs stored in the storage medium may perform the steps in the trading strategy backtesting method according to any of the embodiments of the present disclosure, the computer programs can achieve the beneficial effect of the trading strategy backtesting method according to any of the embodiments of the present disclosure, the details of which may refer to the previous embodiments and will not be repeated here.

The embodiments of the present disclosure further provide a computer program product, and the computer program product includes computer instructions stored in a computer-readable storage medium. A processor of a computer device reads the computer instructions from the computer-readable storage medium, and the processor executes the computer instructions, such that the computer device implements the corresponding process in the trading strategy backtesting method according to any of the embodiments of the present disclosure, which will not be repeated herein for simplicity.

The embodiments of the present disclosure further provide a computer program, and the computer program includes computer instructions stored in a computer-readable storage medium. A processor of a computer device reads the computer instructions from the computer-readable storage medium, and the processor executes the computer instructions, such that the computer device implements the corresponding process in the trading strategy backtesting method according to any of the embodiments of the present disclosure, which will not be repeated herein for simplicity.

The trading strategy backtesting method and apparatus, and the storage medium according to the embodiments of the present disclosure are described in detail above, and in the present disclosure, specific examples are used to describe the principle and implementation of the present disclosure. The description of the above embodiments is only used to help understand the method of the present disclosure and its core ideas. At the same time, those skilled in the art may make changes in the specific implementation and scope of application according to the ideas of the present disclosure. In summary, the content of this specification should not be understood as a restriction on the present disclosure.

What is claimed is:

1. A trading strategy backtesting method, comprising:
providing a display interface with a graphical function interface, wherein the display interface is configured to provide a display interface for a trading strategy and an editing interface for a trading strategy element;
generating a target trading strategy in response to a strategy editing operation for the editing interface, and converting the target trading strategy into a corresponding strategy script, wherein the target trading strategy comprises a strategy condition for at least one of cross-market, cross-category, and cross-cycle;
obtaining backtesting data corresponding to the target trading strategy;
performing a backtesting process on the target trading strategy based on the backtesting data and the strategy script to generate a backtesting report, wherein the backtesting report comprises a backtesting image corresponding to backtesting time, and wherein in the backtesting process, a time lapse process is performed cyclically, and a backtesting speed is determined based on an operating efficiency of an currently operated computer device, to control a speed of a real time and the backtesting time; and
displaying the backtesting image in the backtesting report dynamically based on the display interface.

2. The trading strategy backtesting method according to claim 1, wherein when the target trading strategy comprises the strategy condition for cross-market, the obtained backtesting data comprises historical data corresponding to a trading target in different markets; and
said performing the backtesting process on the target trading strategy based on the backtesting data and the strategy script to generate the backtesting report comprises:
determining a virtual account with a single-currency deposit among at least one virtual account corresponding to a target user as the target account; and
determining, during the backtesting process, when a first currency as a denomination currency for the trading target and a second currency as a deposit currency in the target account are inconsistent, an amount in the second currency corresponding to the denomination currency for the trading target based on a historical exchange rate between the first currency and the second currency, and performing the backtesting process on the target trading strategy based on the amount in the second currency corresponding to the denomination currency of the trading target to generate the backtesting report for characterizing the cross-market.

3. The trading strategy backtesting method according to claim 1, wherein when the target trading strategy comprises the strategy condition for cross-category, the obtained backtesting data comprises historical data corresponding to trading targets in different categories; and
said performing the backtesting process on the target trading strategy based on the backtesting data and the strategy script to generate the backtesting report comprises:
obtaining historical K-line data corresponding to all trading targets in the backtesting data, and marking time information of the historical K-line data based on timestamps; and
managing, during the backtesting process, a backtesting progress based on the timestamps, to generate the backtesting report for characterizing the cross-category based on different time intervals and the time information of the historical K-line data.

4. The trading strategy backtesting method according to claim 1, wherein when the target trading strategy comprises the strategy condition for cross-cycle, the obtained backtesting data comprises historical data corresponding to a trading target in different cycles; and
said performing the backtesting process on the target trading strategy based on the backtesting data and the strategy script to generate the backtesting report comprises:
obtaining historical K-line data corresponding to the trading target in different cycles in the backtesting data; and
re-aggregating, during the backtesting process, when a K-line in first historical K-line data corresponding to a first cycle in the different cycles has not ended, for generating the backtesting image, a K-line corresponding to the first historical K-line data based on a predetermined cycle and the first historical K-line data corresponding to the first cycle, to generate the backtesting report for characterizing the cross-cycle, wherein a time length of the first cycle is greater than a time length of the predetermined cycle.

5. The trading strategy backtesting method according to claim 1, wherein when the target trading strategy comprises the strategy conditions for cross-market and cross-category, the obtained backtesting data comprises historical data corresponding to trading targets in different markets and different categories; and
said performing the backtesting process on the target trading strategy based on the backtesting data and the strategy script to generate the backtesting report comprises:
determining a virtual account with a single-currency deposit among at least one virtual account corresponding to a target user as a target account;
determining, when a first currency as a denomination currency of the trading targets and a second currency as a deposit currency in the target account are inconsistent, an amount in the second currency corresponding to the denomination currency for the trading targets based on a historical exchange rate between the first currency and the second currency;
obtaining historical K-line data corresponding to all trading targets in the backtesting data, and marking time information of the historical K-line data based on timestamps; and
managing, during the backtesting process, a backtesting progress based on the timestamps, to perform the backtesting process on the target trading strategy, based on different time intervals, the time information of the historical K-line data, and the amount in the second currency corresponding to the denomination currency for the trading targets, to generate the backtesting report for characterizing the cross-market and the cross-category.

6. The trading strategy backtesting method according to claim 1, wherein the target trading strategy comprises the strategy conditions for cross-market and cross-cycle, the obtained backtesting data comprises historical data corresponding to trading targets in different markets and different cycles; and
said performing the backtesting process on the target trading strategy based on the backtesting data and the strategy script to generate the backtesting report comprises:
determining a virtual account with a single-currency deposit among at least one virtual account corresponding to a target user as a target account;
determining, when a first currency as a denomination currency for the trading targets and a second currency as a deposit currency in the target account are inconsistent, an amount in the second currency corresponding to the denomination currency for the trading targets based on a historical exchange rate between the first currency and the second currency;
obtaining historical K-line data corresponding to all trading targets in the backtesting data;
re-aggregating, when a K-line in first historical K-line data corresponding to a first cycle in the different cycles has not ended, a K-line corresponding to the first historical K-line data based on a predetermined cycle and the first historical K-line data corresponding to the first cycle, wherein a time length of the first cycle is greater than a time length of the predetermined cycle; and
performing the backtesting process on the target trading strategy based on the amount in the second currency corresponding to the denomination currency for the trading targets and the re-aggregated K-line corresponding to the first historical K-line data, to generate the backtesting report for characterizing the cross-market, and the cross-cycle.

7. The trading strategy backtesting method according to claim 1, wherein when the target trading strategy comprises the strategy conditions for cross-market, cross-category, and cross-cycle, the obtained backtesting data comprises historical data corresponding to trading targets in different markets, different categories, and different cycles; and
said performing the backtesting process on the target trading strategy based on the backtesting data and the strategy script to generate the backtesting report comprises:
determining a virtual account with a single-currency deposit among at least one virtual account corresponding to a target user as a target account;
determining, when a first currency of a denomination currency for the trading targets and a second currency in a deposit currency of the target account are inconsistent, an amount in the second currency corresponding to the denomination currency for the trading targets based on a historical exchange rate between the first currency and the second currency;
obtaining historical K-line data corresponding to all trading targets in the backtesting data, and marking time information of the historical K-line data based on timestamps;
re-aggregating, when a K-line in first historical K-line data corresponding to a first cycle in the different cycles has not ended, a K-line corresponding to the first historical K-line data based on a predetermined cycle and the first historical K-line data corresponding to the first cycle, wherein a time length of the first cycle is greater than a time length of the predetermined cycle; and
managing, during the backtesting processing, a backtesting progress based on the timestamp, to perform the backtesting process on the target trading strategy, based on different time intervals, the time information of the historical K-line data, the amount in the second currency corresponding to the denomination currency for the trading targets, and the re-aggregated K-line corresponding to the first historical K-line data, to generate the backtesting report for characterizing the cross-market, the cross-category, and the cross-cycle.

8. The trading strategy backtesting method according to claim 1, further comprising, during the backtesting process:
performing, when the backtesting processing comprises at least one of position processing, cash processing, and order processing, the backtesting process by means of dynamic forward adjustment, wherein the dynamic forward adjustment is to trigger forward adjustment once for all data before a current moment whenever at least one event of stock-split, stock-merger, and dividend occurs for a target company in the backtesting data.

9. The trading strategy backtesting method according to claim 1, wherein the backtesting report comprises a plurality of backtesting images corresponding to the backtesting time, and
said displaying the backtesting image in the backtesting report dynamically based on the display interface comprises:
playing the plurality of backtesting images in accordance with a progress bar based on a player in the display interface, wherein the progress bar comprises a plurality of progress points each associated with corresponding backtesting data and a corresponding backtesting image.

10. The trading strategy backtesting method according to claim 9, further comprising, prior to playing the plurality of backtesting images in accordance with the progress bar:
determining the plurality of progress points based on all predetermined operating frequencies corresponding to the target trading strategy and based on the backtesting time; and
determining a playing speed of the progress bar corresponding to 1× speed based on the backtesting time and the plurality of progress points, and when the playing speed of the progress bar corresponds to a plurality of candidate speed levels, determining a current playing speed of the progress bar based on a currently selected target speed level and the playing speed of the progress bar corresponding to the 1× speed, wherein the plurality of selectable speed levels comprise a maximum level and one or more levels other than the maximum level, and a playing speed corresponding to each of the one or more level is smaller than a backtesting calculation speed corresponding to the maximum level.

11. The trading strategy backtesting method according to claim 10, wherein said determining the plurality of progress points based on all predetermined operating frequencies corresponding to the target trading strategy and based on the backtesting time comprises:
calculating a historical trading time period of each trading target based on historical K-line data corresponding to a base frequency;
determining, based on all the predetermined operating frequencies corresponding to the target trading strategy, a time point to perform the target trading strategy each time in the historical trading time period of each trading target, wherein the base frequency is lower than each operating frequency; and
integrating time points corresponding to all trading targets, and performing a sorting process and a deduplication process based on timestamps to obtain the progress points for the currently played progress bar.

12. The trading strategy backtesting method according to claim 11, further comprising, when playing the plurality of backtesting images in accordance with the progress bar:
calculating a position of a refreshed progress bar each time based on the current playing speed of the progress bar, to achieve a smooth movement of the progress bar based on the position of the refreshed progress bar each time.

13. The trading strategy backtesting method according to claim 12, wherein said calculating the position of the refreshed progress bar each time based on the current playing speed of the progress bar, to achieve the smooth movement of the progress bar based on the position of the refreshed progress bar each time comprises:
recording, when the current playing speed is the backtesting calculation speed corresponding to the maximum level, a calculation interval between every two time points, and determining average time consumption based on the calculation interval, and determining the position of the refreshed progress bar each time based on the average time consumption and a position interval between every two time points on the interface; or
calculating, when the current playing speed is the target speed corresponding to any other level, an expected playing interval between every two time points based on the target speed, and calculating the position of the refreshed progress bar each time based on the expected playing interval and the position interval between every two time points on the interface.

14. The trading strategy backtesting method according to claim 10, wherein said playing the plurality of backtesting images in accordance with the progress bar comprises:
displaying, in response to a frequency switching instruction inputted by a user, a K-line corresponding to a target frequency in the frequency switching instruction in the backtesting image dynamically with a playing progress of the progress bar, wherein the target frequency is a frequency selected from the operating frequencies.

15. The trading strategy backtesting method according to claim 10, further comprising:
calculating, when the target trading strategy for performing the backtesting processing comprises a plurality of different target trading strategies, the backtesting data corresponding to the plurality of different target trading strategies independently, to generate a backtesting report corresponding to each of the plurality of different target trading strategies.

16. The trading strategy backtesting method according to claim 10, further comprising:
Storing, when obtaining the backtesting data corresponding to the target trading strategy, data change information for each backtesting time point in the backtesting data, and snapshot information corresponding to a predetermined backtesting time interval; and
generating, when generating the backtesting report, the backtesting image in the backtesting report based on the data change information and the snapshot information.

17. The trading strategy backtesting method according to claim 10, further comprising:
generating, when generating the backtesting report, the backtesting image corresponding to the backtesting time in the backtesting report based on the backtesting data and a data type of the backtesting data, wherein:
if the data type is incremental data, when the incremental data is updated in the backtesting image, only new data in the incremental data is drawn on the basis of original data; or
if the data type is overwriting data, when the overwriting data is updated in the backtesting image, the original data is compared with the overwriting data, and a field having a data change in the overwriting data is drawn based on a result of the comparison.

18. The trading strategy backtesting method according to claim 1, wherein said displaying the backtesting image in the backtesting report dynamically comprises:
playing back the backtesting image in the backtesting report dynamically in response to a playback instruction.

19. A trading strategy backtesting apparatus, comprising:
a providing unit configured to provide a display interface with a graphical function interface, wherein the display interface is configured to provide a display interface for a trading strategy and an editing interface for a trading strategy element;
a generating unit configured to generate a target trading strategy in response to a strategy editing operation for the editing interface, and converting the target trading strategy into a corresponding strategy script, wherein the target trading strategy comprises a strategy condition for at least one of cross-market, cross-category, and cross-cycle;
an obtaining unit configured to obtain backtesting data corresponding to the target trading strategy;
a backtesting unit configured to perform a backtesting process on the target trading strategy based on the backtesting data and the strategy script to generate a backtesting report, wherein the backtesting report comprises a backtesting image corresponding to backtesting time, and wherein in the backtesting process, a time lapse process is performed cyclically, and a backtesting speed is determined based on an operating efficiency of an currently operated computer device, to control a speed of a real time and the backtesting time; and
a display unit configured to display the backtesting image in the backtesting report dynamically based on the display interface.

20. A computer-readable storage medium having a computer program stored thereon, wherein the computer program is adapted to be loaded onto a processor for performing a trading strategy backtesting method, the method comprising:
providing a display interface with a graphical function interface, wherein the display interface is configured to provide a display interface for a trading strategy and an editing interface for a trading strategy element;
generating a target trading strategy in response to a strategy editing operation for the editing interface, and converting the target trading strategy into a corresponding strategy script, wherein the target trading strategy comprises a strategy condition for at least one of cross-market, cross-category, and cross-cycle;
obtaining backtesting data corresponding to the target trading strategy;
performing a backtesting process on the target trading strategy based on the backtesting data and the strategy script to generate a backtesting report, wherein the backtesting report comprises a backtesting image corresponding to backtesting time, and wherein in the backtesting process, a time lapse process is performed cyclically, and a backtesting speed is determined based on an operating efficiency of an currently operated computer device, to control a speed of a real time and the backtesting time; and
displaying the backtesting image in the backtesting report dynamically based on the display interface.
